(19) United States
(12) Patent Application Publication
(10) Pub. No.: US 2003/0004859 A1
(43) Pub. Date: Jan. 2, 2003

(54) Method and system for facilitating secure transactions

(76) Inventors: John C. Shaw, Westport, CT (US); Richard A. Holway, Winchester, CT (US); Mike N. Alex, Wyckoff, NJ (US); James D. Nikolai, Great Neck, NY (US); Thomas P. Joyce, Port Washington, NY (US); Saul D. Hilsenrath, Chatham, NJ (US); Daniel E. Speers, Morristown, NJ (US)

Correspondence Address: MORGAN LEWIS & BOCKIUS LLP, 1111 PENNSYLVANIA AVENUE NW, WASHINGTON, DC, 20004, US

(21) Appl. No.: 10/032,535

(22) Filed: Jan. 2, 2002

Related U.S. Application Data
(63) Continuation-in-part of application No. 09/570,562, filed on May 12, 2000.
(63) Continuation-in-part of application No. 09/569,135, filed on May 11, 2000.
(60) Provisional application No. 60/134,207, filed on May 14, 1999.
(60) Provisional application No. 60/133,655, filed on May 11, 1999.

(51) Int. Cl. G06F 17/60

(52) U.S. Cl. 705/37

(57) ABSTRACT

A secure, computer based method and system for anonymously and confidentially matching indications of interest from potential buyers and sellers is disclosed which facilitates human intervention for negotiating a final transaction between matched parties. Potential buyers and sellers independently enter indications of interest into a central processing system which operates on a network containing a secure station and a plurality of remote user terminals linked to the secure station. The indications identify a security (such as a trading equity), price, type of order, duration, and other related information. A memory at the secure station stores user data and multiple prospective transaction entries received from the user terminals. Indications of interest are compared against those already in the system to determine whether buy side and sell side orders are sufficiently similar to generate a match. When a match occurs, each party and/or its authorized representative is given contact information for the other party and/or its authorized representative to facilitate negotiation of a final transaction. Transacting parties remain anonymous, and transaction information remains confidential, until a match occurs. Transacting parties have an option of adding conditions such as acceptable price, amount and time limits, to their prospective transaction entries. Other options enable parties to place such entries in a pending mode in which the entry is not compared with other entries, and later change the mode form pending to active.

### RELATED APPLICATIONS

This application is a continuation in part of U.S. patent application Ser. No. 09/569,135 filed on May 11, 2000 and entitled “Secure System For Trading Fungible Commodities” and U.S. patent application Ser. No. 09/570,562 filed on May 12, 2000 and entitled “Method And System For Anonymously And Confidentially Matching Contraparties To A Transaction Which Results In Human Negotiation Of The Final Terms Of A Transaction”, the subject matter of both of which is incorporated herein by reference.

### FIELD OF THE INVENTION

The present invention relates to methods and system for securely matching potential buyers and potential sellers in an anonymous and confidential manner. Buyers and sellers enter indications of interest into a central processing system that matches these indications and then informs the buyers/sellers and/or their authorized representatives of the match in order to facilitate the buyers/sellers and/or their authorized representatives to negotiate a transaction. More particularly, the present invention relates to a computerized networked communication and processing system wherein the identification, pairing and alerting of pre-qualified counter-parties with indications of potential transactional interest in certain properties is securely effectuated in an automatic, confidential and anonymous manner without prior disclosure of those interests.

### BACKGROUND OF THE INVENTION

The volume of securities transactions completed through computerized crossing networks has grown exponentially in recent years. This growth, fueled in part by the more prevalent use of the Internet by individual investors for buying and selling securities, and in part by the overall increase in market activity, has resulted in a variety of different computer systems that anonymously match buyers and sellers to execute trades. Through several well established trading systems such as the Instinet Crossing Network (in excess of 35 million shares per day) and POSIT (in excess of 25 million shares per day), investors automatically trade millions of shares on an anonymous basis each day, and through new companies such as OptiMark, (assignee of U.S. Pat. No. 5,689,652 to Lupien et al. hereinafter referred to as the OptiMark System), investors have been given new ways to enter order data and greater flexibility in matching potential buyers with potential sellers.

These systems bring a number of advantages to investors, including the identification of contraparties and anonymity, but each also contains a common element: transactions are automatically executed when a match occurs. While this method of trading works well in most circumstances, it is not the most efficient method for trading large blocks of securities. These transactions are better handled through negotiated transactions that allow the parties to account for numerous other factors that become relevant when buying or selling a large block of securities. The above mentioned methods and systems fail to permit human involvement after a crossing network matches an order.

Each of these prior art arrangements provides an anonymous order crossing system that results in an automatic execution that does not allow human intervention and negotiation once a match occurs. For example, the OptiMark System allows traders to anonymously input a satisfaction density profile and maximum size limit which characterizes the trader's degree of satisfaction to trade at any and all prices and sizes, up to an aggregate limit. The system then matches buyers and sellers at specific call times throughout the trading day, but results in an automatic execution and does not allow for human intervention and negotiation before execution. Similarly, U.S. Pat. No. 5,794,207 to Walker et al. (“Walker”) involves a method and apparatus for conducting purchase transactions between buyers and sellers. In Walker, a purchase offer from a prospective buyer automatically binds the buyer to the transaction when the potential seller accepts the offer.

A principal's proprietary interest in transacting a particular item represents that investor's desire to realize an investment objective. This information is valuable and is the property of the principal until disclosed. Special definitions of this particular information are provided below. How this special information is handled and protected by the system and why this may be important to principals is explained in later sections.

Previous systems require one or both parties to unilaterally display, divulge and/or broadcast their proprietary transactional interests in the hopes of eliciting a response from natural counter-parties. A principal's interests can be, and often are, jeopardized when the transactional interest information representing its desire to put a proprietary investment decision into action is divulged ahead of locating and contacting a qualified counter-party.

Previous systems also require a firm order to transact an item that potentially commits parties to execute a transaction before any negotiation can occur. Resulting executions without the opportunity for prior negotiations are often not in the principals' best interests and are often highly inefficient in fulfilling their investment objectives.

Unfulfilled transaction interest information has value for a number of reasons: First, unfulfilled transactional interest information typically represents a proprietary investment idea generated through work and analysis of the principal.

Second, this interest, if divulged ahead of fulfillment, can often adversely affect the liquidity (availability and price) of the item. Generally, the larger the transactional interest and/or the less liquid of an item, the greater the probability that the unilateral exposure of transactional interest will affect its price adversely.

Third, pre-fulfillment disclosure of the identity of the principal often has an adverse impact if, for example, the principal is known to be an intelligent, large and/or aggressive investor.

Furthermore, current mechanisms whereby natural counter-parties try to find one another are far from efficient. This causes higher costs for investors and the economy as a whole (wasted time and effort, higher transaction costs, negative price impacts, missed investment opportunities, unrealized and ineffective allocations of capital). Investors and fiduciaries often withhold their transaction interests from disclosure for fear of incurring the inordinate costs due to these inefficiencies.

Investors often will not expose even a marketable order to transact unless they are assured that there is a qualified counter-side to their transactional interest. These contingent, unfulfilled transaction interests on the sideline represent a large pool of potential and desired liquidity currently unavailable to participants. Transactions that should occur do not, reducing the efficiency of capital allocation.

These latent or contingent transaction interest types can become actual orders to transact when certain specific conditions exist (anonymity, confidentiality, qualified natural counter-party identification, etc.). This system is proposed to increase the efficiency of capital allocation and provide those specific conditions whereby principals with contingent and/or latent transactional interests can more readily pursue their investment interests.

Investors need a system that affords an opportunity to anonymously and confidentially locate a natural counter-party interested in transacting the same specific investment item without either side having to disclose its proprietary transactional interest information beforehand in order to obtain such an opportunity. Furthermore, investors need a system that does not require principals to subject themselves to the risk of having to commit to an unwanted execution in order to potentially find the other side.

A system that could efficiently, anonymously and confidentially locate and set-up communications between natural parties with counter-side interests would be helpful and desirable to investors. Furthermore, this system would ensure that all users of the system could receive alerts to a pairing of counter-side transactional interests simultaneously so that all would be treated equally by the system.

This system should make full use of recent advances in information management; communications; networking security; the Internet; The Financial Information Exchange (FIX) protocol; Virtual Private Networks; Web-based personal page publishing; data transmission encryption.

### SUMMARY OF THE INVENTION

An object of the present invention to provide an apparatus and method that affords users who enter transactional interest indications into the system with an opportunity to securely, anonymously, and automatically pair-off with any users who have similarly entered counter-side transactional interest indications in the same item.

Another object of the present invention to provide a secure networked communication system wherein users can enter their transactional interest in certain items into the system in an anonymous and secure manner from remote terminals.

A further object of the present invention to provide a secure information management system wherein transactional interest indications entered by users are held in a database residing on a secure server such that they remain protected and undisclosed.

Another object of the present invention to provide a secure information management system wherein the occurrence of matching counter-side interest indications (i.e., synapse or pair-off) is immediately recognized via logic processing therein.

A still further object of the present invention to provide a secure information management system wherein the occurrence of a synapse leads to the simultaneous generation of messages (Alerts) specific to the users whose indications of transactional interest have paired-off at that moment, with the alert addressed only to those users.

A yet another object of the present invention to provide a system wherein all users are treated equally and where no one user will possess any advantage over any other user and where all processing and communications will be kept confidential at all times.

A yet further object of the present invention to eliminate the limitations and disadvantages of the related prior art by permitting human intervention and negotiation after a computerized anonymous match has occurred.

It is another object of the present invention to preserve the anonymity of contraparties until after a match has occurred.

It is a further object of the present invention to preserve the confidentiality of the indications of interest entered by the parties until after a match has occurred.

To achieve these and other objects, there is provided a secure system for treating fungible commodities. The system has a network including a secure station and a plurality of remote user terminals having respective user identities and communicatively linked to the secure station for data transmission between the secure station and the user terminals. A memory of the secure station stores user data including the user identities, and stores transaction data in the form of multiple prospective transaction entries received from the user terminals. Each entry includes a fungible item indication and a transaction side indication identifying one of two opposing transaction sides. A search component is operatively coupled to the memory and adapted to perform a comparison of the stored entries with respect to the fungible item indications and the transaction side indications. Based on that comparison, the search component selects sets of two or more stored entries as matching entries having the same fungible item indication and together including transaction side indications identifying the opposing transaction sides. A message sending component is operatively associated with the search component and the memory. The message sending component is adapted, in response to the selection of each set of matching entries, to generate a prospective transaction message including the transaction indication and the user identity corresponding to each of the matching entries. The message sending component further is adapted to provide the prospective transaction message to the user terminals associated with the corresponding user identities, thus to facilitate an interaction among users associated with the user identities to complete a transaction involving the fungible item. A data security component is provided for restricting access to any given prospective transaction entry stored in the memory to (i) the user identity corresponding to the given entry; and (ii) the user identities corresponding to the other entries in any of the sets of entries that includes the given entry.

The remote user terminals can be linked to the secure station for either wireless data transmission or by direct lines. In exemplary embodiments, users provide prospective transaction entries by entering fungible item indications directly, or by gaining access to a menu, from which a particular fungible item indication (code) can be selected and entered. While the most frequently used transaction side indications are “buy” and “sell,” other pairs of transaction sides are contemplated, e.g., “borrow/lend.”

Preferably the search component compares the entered fungible item indication codes. For a potential set of entries having the same fungible item indication, a set of matching entries is realized if the members of the potential set include at least one entry on each side of the transaction. While sets most frequently involve pairs of entries, either side of the transaction may include two or more entries.

The selection of a set of matching entries triggers the message sending component to generate and send the prospective transaction message to all matched users. Preferably the user information includes instructions that govern notification, e.g., whether a principal or agent is to be notified, instructions to other parties in the set regarding individuals to contact, and telephone numbers, e-mail addresses, or other information to facilitate contact.

In accordance with the present invention, a secure networked communication and information management system is made available by which investors can communicate their transaction interest indications anonymously and confidentially via a network connection to a central messaging/communications and database/processing server array with the purpose of anonymously and confidentially locating a potential natural counter-party to their transactional interests in certain investment items.

Only in the event of a synapse will an alert message be generated and sent. These messages are sent only to the users who have paired-off. These messages are sent in the same secure environment used for the entry of transaction interests. The contents of the alert message may vary according to the application and user options but it essentially conveys information to only the parties or agents who have been matched as follows:

1. A message indicating that a pair-off (synapse) in a certain item has occurred;

2. Pertinent details and descriptors of the particular item of transactional interest;

3. Alternative contact options (A-C), typically including a name and phone number, e-mail, fax or point-to-point network routing addresses, etc.:

A. Principal Direct: Each principal receives contact information allowing each to communicate with the counter-party;

B. Agents Representing Principals: Agents designated by principals receive parts 1 and 2 above, the client's identity, and the contact information allowing each counter-party agent to communicate with the other on the client's behalf;

C. Hybrid: Combinations of A and B above with corresponding contact information conveyed.

The System

The system is based on a network with a secure central station coupled to remote stations used by parties to enter transaction interest information and receive alerts. Use of the application and system is illustrated below using numismatic coins as the item of transactional interest.

Further examples of items where this invention could work may be found anywhere a buyer and seller of fungible item are seeking one another, e.g., financial, commodity, and derivative securities, collectibles in addition to coins such as philatelic stamps, baseball cards, wholesale goods, etc.

Each party can enter a transactional interest or indication including an item identity and side (buyer or seller). The indication can be withdrawn from the system at any time. Current price monitoring is the responsibility of each entering party. However, a party can enter price or time limits that permit automatic changes in the activation state.

Meanwhile, other parties are using the system to enter similar information. None of the individual entries is broadcast. Instead, the secure central station compares entries to find a synapse (or coincidence event) involving a buyer and a seller (or perhaps more than one of either) of the same item.

When a synapse occurs, all matched buyers and sellers (or their appointed agents) are informed simultaneously that a synapse has occurred. Up to this point, none of the parties knows the identity of the other party (or parties) involved. When a synapse occurs, the contra-parties (or their agents) are put in communication with one another. The transaction is then negotiated between the matched parties or their agents.

This invention is not a deal-making or execution system. It is an information management system allowing interested counter-parties to securely find one another without divulging their transactional interests ahead of time. Any negotiations potentially leading to a deal or execution resulting from a pair-off in the system are done away from and without the system. The system efficiently and confidentially identifies and puts natural counter-parties expressing an opposing interest in transacting a particular item together so that they can then proceed outside of the system and negotiate a mutually desired transaction.

Unlike current transaction interest location systems, this system divulges neither principal identities nor their proprietary transaction interest information as a prerequisite to potentially finding a qualified natural party with concurrent counter-side interests in transacting a specific item.

To achieve these and other advantages and in accordance with the purpose of the present invention, as embodied and broadly described, a method for anonymously and confidentially identifying contraparties to a transaction and notifying an authorized representative of the contraparties to contact the contraparties in order to negotiate a transaction is provided, including the following steps: receiving indications of interest from potential buyers and potential sellers into a central processing system, each indication of interest involving a purchase or sale of a specific item; anonymously comparing indications of interest received from potential buyers with indications of interest received from potential sellers within the central processing system to determine whether a match has occurred; identifying contraparties to a transaction based on said determination of whether a match has occurred; notifying the authorized representative of the contraparties that a match has occurred; providing contact information to the authorized representative to allow the authorized representative to contact the contraparties so that a transaction can be negotiated between the contraparties; and consummating the transaction between the contraparties through direct negotiation between the authorized representative and the contraparties.

In another aspect, a method for anonymously and confidentially identifying contraparties to a transaction and introducing authorized representatives of each respective contraparty to each other in order for the authorized representatives to negotiate a transaction is provided, including the following steps: receiving indications of interest from potential buyers and potential sellers into a central processing system, each indication of interest involving a purchase or sale of a specific item; anonymously comparing indications of interest received from potential buyers with indications of interest from potential sellers within the central processing system to determine whether a match has occurred; identifying contraparties to a transaction based on said determination of whether a match has occurred; notifying the contraparties and their respective authorized representatives that a match has occurred; providing contact information to each of the authorized representatives to allow the authorized representatives of the contraparties to contact each other so that a transaction can be negotiated between the contraparties; and

consummating the transaction between the contraparties through direct negotiation between the authorized representatives of the contraparties.

In another aspect, a method for anonymously and confidentially identifying contraparties to a transaction and disclosing contact information of the contraparties between the contraparties in order to allow them to negotiate a transaction is provided, including the following steps: receiving indications of interest from potential buyers and potential sellers into a central processing system, each indication of interest involving a purchase or sale of a specific item; anonymously comparing indications of interest received from potential buyers with indications of interest from potential sellers within the central processing system to determine whether a match has occurred; identifying contraparties to a transaction based on said determination of whether a match has occurred; notifying each of the contraparties to a transaction that a match has occurred; providing contact information to each of the contraparties to a transaction to allow the contraparties to contact each other to negotiate their transaction; and consummating the transaction between the contraparties through direct negotiation between the contraparties.

Another aspect of the present invention provides an information management system for confidentially identifying contraparties to a transaction and introducing them and/or their agents to each other in order to allow them to negotiate the transaction, including means for receiving indications of interest from potential buyers and potential sellers into a central processing system; means for confidentially and anonymously comparing the received indications of interest from potential buyers and potential sellers to determine whether a match has occurred, and thus whether contraparties to a transaction have been identified; and means for informing identified contraparties that a match has occurred and for providing contact information between the identified contraparties so that further negotiations may take place between the contraparties to consummate their mutually desired transaction.

### BRIEF DESCRIPTION OF THE DRAWINGS

The above objects and features of the present invention will be more apparent from the following description of the preferred embodiments with reference to the accompanying drawings.

FIG. 1 illustrates a block diagram of a system according to exemplary embodiments of the present invention;

FIG. 2A and 2B illustrate block diagrams of security/communications features and a host server array;

FIG. 3 illustrates a block diagram of the software environment according to an exemplary embodiment of the present invention;

FIGS. 4A to 4B illustrate records, fields, and database tables used in the system of the present invention;

FIGS. 5A and 5B illustrate a high-level flow chart describing operation according to exemplary embodiments of the present system;

FIGS. 6A to 6D illustrate a flow chart describing online communication and data transfer between a host server array and remote users;

FIGS. 7A to 7C illustrate top-level flow charts highlighting options by which remote users utilize the host server array and the communications, processing, messaging, and alerting functions of exemplary embodiments of the present system;

FIG. 8 illustrates a schematic view of system components of exemplary embodiments of the present invention;

FIG. 9 illustrates a diagram of a stock transaction indication according to exemplary embodiments of the present invention;

FIG. 10 illustrates a block diagram of the information management system of an exemplary embodiment of the present invention;

FIG. 11 illustrates a flow diagram of the method according to an exemplary embodiment of the present invention;

FIG. 12 illustrates a main summary screen of an exemplary embodiment of the present invention that informs a party of various aspects of their current indications;

FIG. 13 illustrates a screen used by a party to add their indications to a system according to an exemplary embodiment of the present invention;

FIG. 14 illustrates a screen used by a party to upload their indications into a system according to an exemplary embodiment of the present invention;

FIG. 15 illustrates a status screen for informing the party of the validity of their input indications;

FIG. 16 illustrates an edit screen for allowing a party to edit its indications before activating the indications;

FIG. 17 illustrates an alert screen for alerting an account executive of a match; and

FIG. 18 illustrates a change settings screen allowing a party to change its default settings and their password.

### DETAILED DESCRIPTION OF PREFERRED EMBODIMENTS

In the following description, for purposes of explanation and not limitation, specific details are set forth, such as particular structures, components, techniques, etc. in order to provide a thorough understanding of the present invention. However, it will be apparent to one skilled in the art that the present invention may be practices in other embodiments that depart from these specific details. In other instances, detailed descriptions of well-known methods, and components are omitted so as not to obscure the description of the present invention.

The preferred exemplary embodiments may be more fully understood based on the following definitions:

Transaction Interest: A principal's proprietary interest in potentially transacting (buy, sell, trade, swap, barter, etc.) a specific item to realize their particular investment objective.

Item of Transaction Interest: An identifiable object or property that may be transacted.

Transaction Interest Indication: An expression of a potential interest in transacting a certain item.

Transaction Interest Information: Details concerning the identity of the principal and the= dimensions of the transaction interest, such as: side of interest (buyer/seller); item; quantity of item desired; special parameters; and contingent factors.

Special Parameters: Further limiting details concerning a transaction interest, such as pricing levels; time periods or duration of interest, etc.

Contingent Factors of Interest: Specified conditions necessary to the validity of a transaction interest, such as when a qualified counter-party is located, or with the assurance that a minimum quantity will be wanted or available at a certain price level, etc.

Order to Transact: A set of instructions from a principal directing that a transaction in a certain item be actively initiated and pursued. A transaction order may be given to an agent, or committed directly, to any number of exchange or marketplace mechanisms.

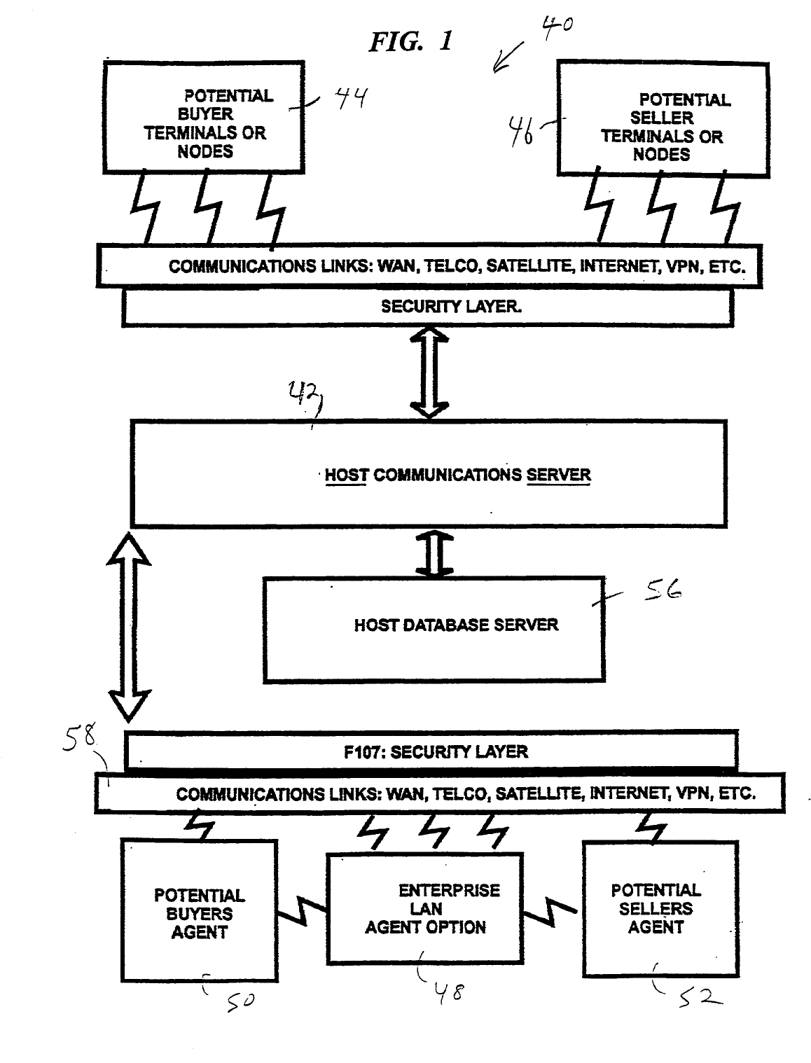

FIG. 1 illustrates a block diagram of the primary elements of a system 40 according to exemplary embodiments of the present invention. In system 40, a host server array 42 exchanges data with a plurality of remote user nodes or terminals 44 and 46, optionally 48-52, through data transmission typically across communications links such as telephone/data transmission lines or frequencies (schematically represented). The host communications server 42 acts as a gateway which securely interfaces the host database server 56 to a network for transmitting data via a common protocol utilized at user terminals.

The system can be connected to users over a network such as the internet; the world wide web (Web); private virtual networks; private dedicated networks; etc., which can allow a multitude of remote users to potentially access the system simultaneously. The host communications server 42 also supports secure direct line modem connections to users. Thus, a variety of user connections and modalities are implied when reference is made to the “net” or “network.”

In accordance with the exemplary embodiment, a host database server 42 is connected to the network. A web server 58 of the host communications server publishes at least an initial first login page accessible to a prospective user. This login page permits pre-authorized users to enter their username/password combinations in order to gain access to a personalized user page published by the server 58. This personalized user page allows users to enter, modify, monitor, and delete indications of transaction interest.

Users gain access via communication links to the host server array by contacting the host gateway. This contact is typically established on a network by sending data packets to an electronic address associated with the host communications server. Security measures and safeguards are initiated and implemented as this initial contact is established.

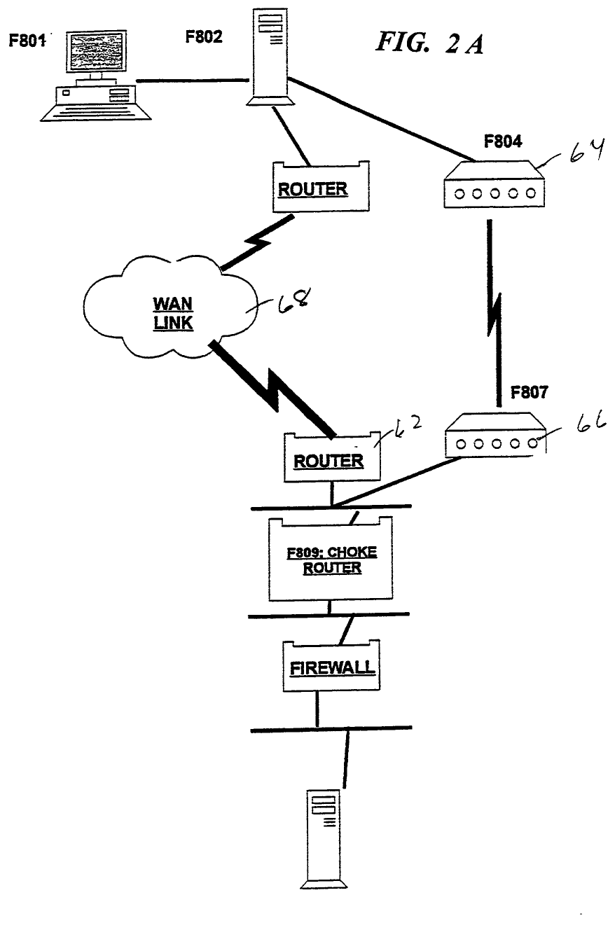

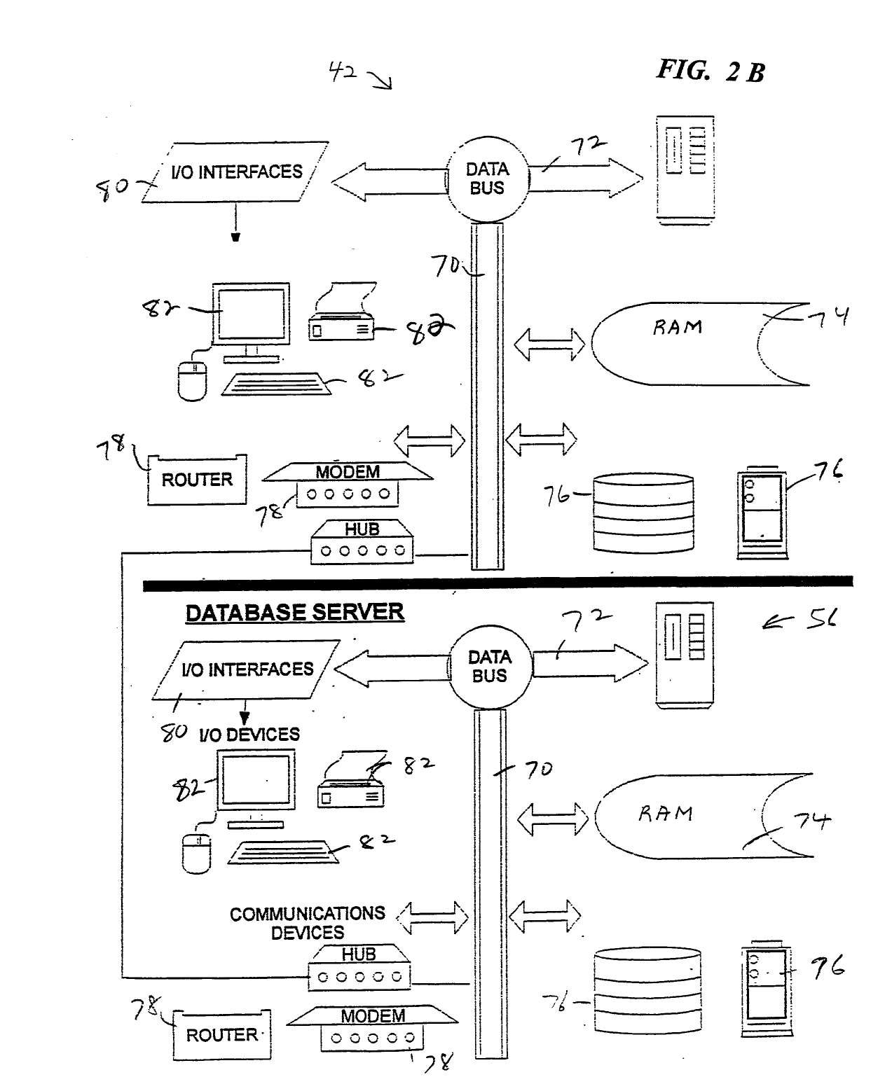

FIG. 2A illustrates a security and communications scheme to establish protected connections for users accessing the host communications server array 42 and to protect the contents of the host database server 56. Users typically have similar security measures as those outlined for the host communications server array 42. Communications links are usually established using a secure socket layer from user site router 60 to system site router 62, or directly from user modem 64 to host modem 66.

Router connections are normally carried over a wide area network (WAN) and contain their own port identification and authentication security routines. WAN links 68 can be established over the Web, the Internet, a private shared network, a virtual private network, or a dedicated circuit (frame relay, 56 kb leased line, ISDN, ATM, etc.). Point to point or simple TCP/IP connections will typically be established with the TCP socket access being configured for user control for security purposes. Direct modem links 64, 66 typically are established over public telephone/data lines and/or frequencies or privately leased lines.

Once a connection is established, the gateway server provides further security checks by presenting a firewall, a login routine with automatic disconnection after a certain number of unsuccessful login attempts, and anti-hacker monitoring of all unauthorized or repeated attempts to access the host database server array 56.

FIG. 2B illustrates a block diagram highlighting a greater detail of the host communications server array 42/56. A central processor unit 70 with read only memory (CPU/ROM) controls system functions and is connected along circuit board data/address bus lines 72 to a random access memory bank (RAM) 74, mass storage devices 76, communications devices 78, and I/O (input/output) interfaces 80 which control corresponding I/O devices 82 such as video monitors, keyboards, and printers.

The communications server includes routers and modems 78 used to exchange information with remote user nodes/terminals over communications links. Other communications devices and combinations may also be used to transfer data between the host communications server and remote users of the system. The host database server 56 includes the elements mentioned above for the host communications server 42. A number of standard internal network components (hub, LAN cards, Cat5 cabling, etc.) are shared by both types of servers and are used to connect the servers into the host server array 42/56.

The host server array is shown using dual servers for simplicity in this example; however, more than two servers can make up the host server array.

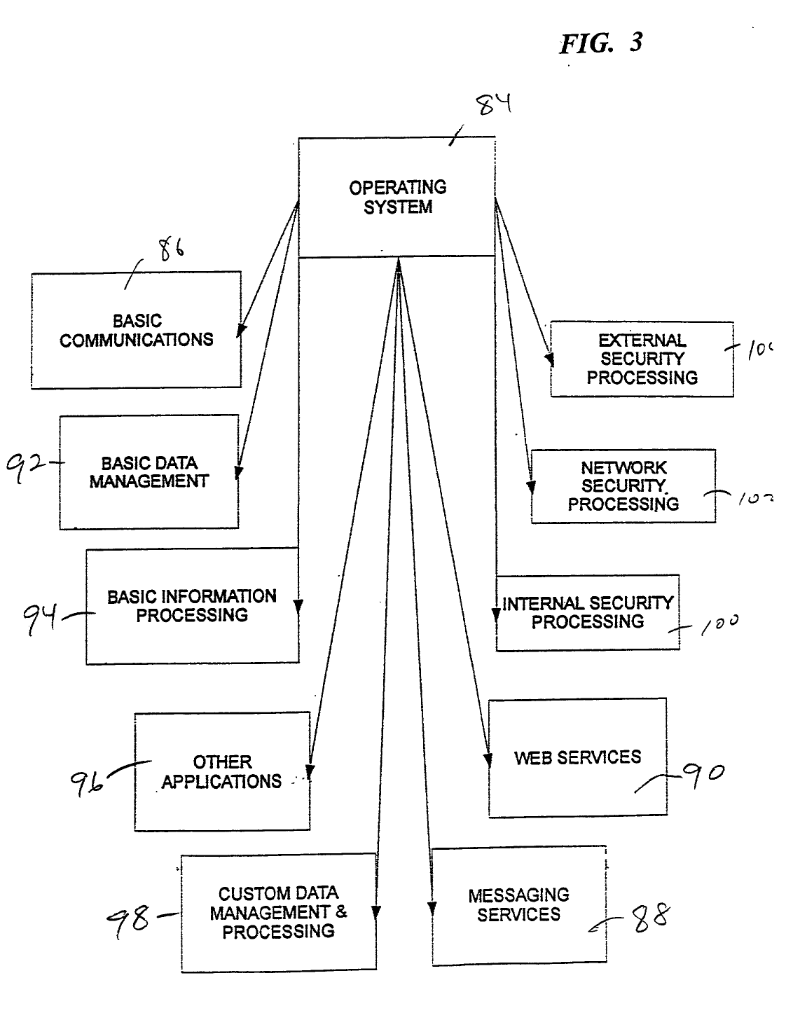

FIG. 3 illustrates the general software configuration of the host communications server array 42/56. The system functions via a network capable operating system 84 which allows for the execution of system and application level programs and processes as follows:

Communications applications 86, 88 and 90 allow encrypted data transfer with various remote user nodes/terminals, such as those referred to above. The communications applications allow prospective buyers and sellers at the remote nodes/terminals to log onto the host system. These applications provide either a direct connection or a user specific web page wherein users can enter, modify, monitor and delete indications of transactional interest without disclosing information about these interests, or about themselves, to any other user or entity. The communications applications also allow for dynamic messaging between the host server array and various users. The communications applications further allow for users (or agents) to be alerted in the case of a pair-off event in the host database server.

The software environment can include further applications 92, 94 supporting the system's basic data management, communications, and information processing capabilities.

Commercially available and/or customized applications 96 may be included in the software environment.

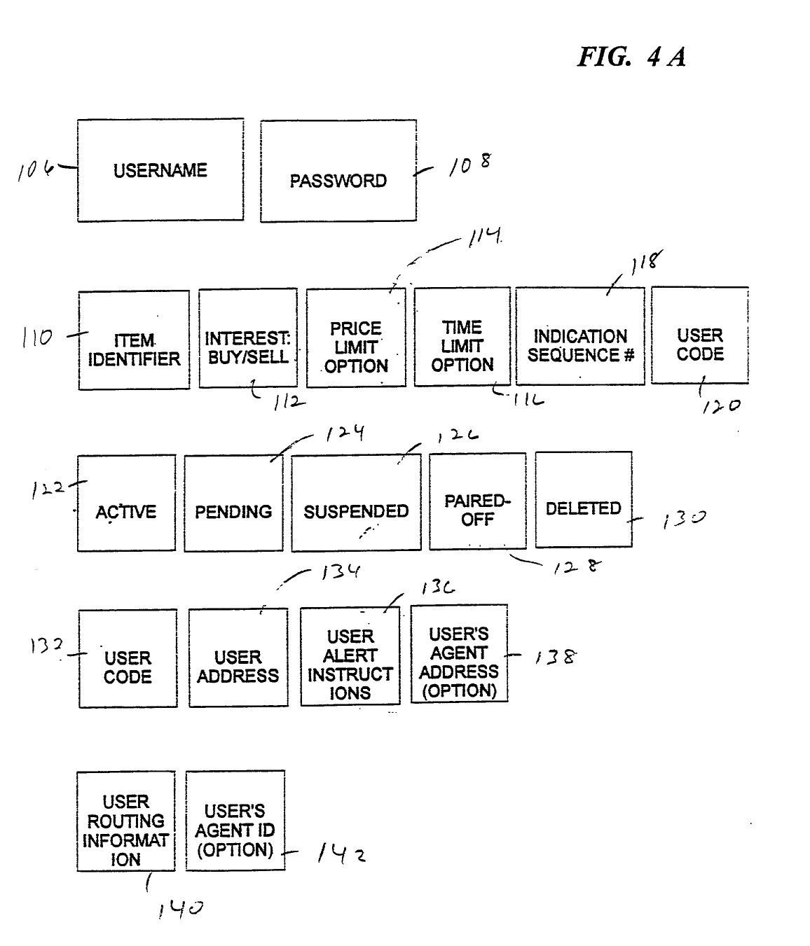

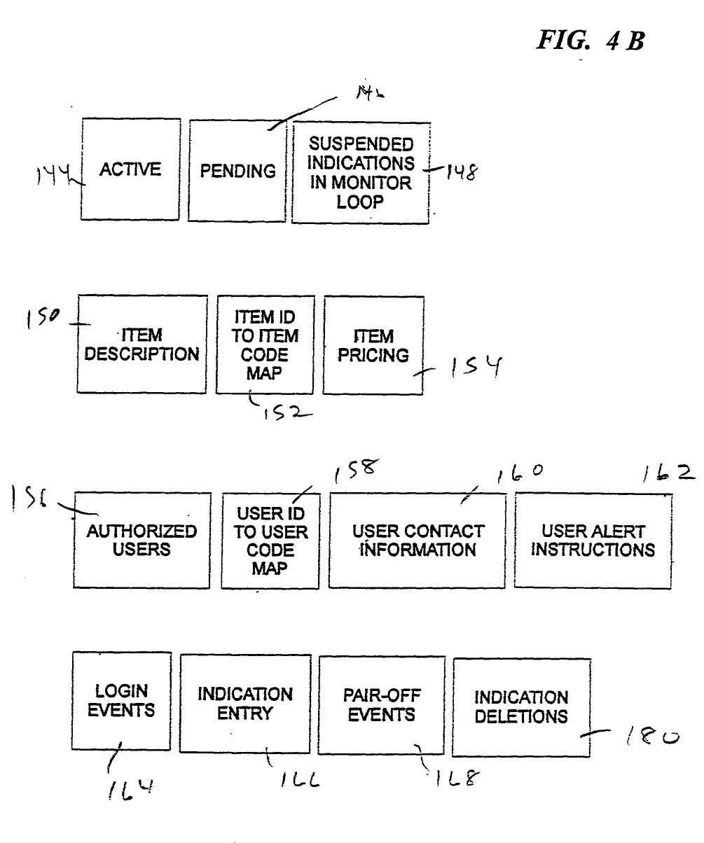

A relational database (data management, storage, and retrieval) application 98 customized to the present invention is present in the software environment to organize, monitor, reflect modifications, allow restricted access, maintain data look-up tables, search, and associate the information entered by users. This information is organized and stored on one or more mass storage devices 76 as governed by the operating system. The information is organized and stored, for example as described below in reference to FIGS. 4A to 4B.

Internal, network and external security processing applications 100, 102 and 104 are also a feature of the software environment described with all servers sharing a network operating level security load but with the majority of the external security applications running on the host communications server 42. Special hardware associated with these security applications may be used and are typically connected to the servers either through system ports or directly to the data bus.

FIGS. 4A and 4B illustrate examples of records and fields created by the data management, storage and retrieval process and the database tables that hold these records according to exemplary embodiments of the present invention. Specific data fields are associated and organized into identifiable records which are themselves further associated and organized into tables. These tables are referenced for retrieving and processing the specific data items and associations needed to fulfill specific requests or routines according to exemplary embodiment of the present invention. The data content at each of these levels includes, for example, the following fields for each authorized user: id, password, name, general address, phone numbers, and fax numbers). Where necessary, records and fields specific to the invention (e.g., user network routing addresses) are identified in the following discussion of the system operation.

With specific reference to FIG. 4A, user identification fields or records include a user name record 106 and a user password 108. Several fields are provided for prospective transaction entries, i.e., transaction interest information. These include an item identification field 110, a transaction side field 112, an optional price limit field 114, an optional time limit field 116, and fields 118 and 120 for an entry sequence number and user code, respectively. Several fields are provided to indicate the status of an entry, including an active field 122, a pending field 124, a suspended field 126. A field 128 is provided for indicating that an entry has been selected for a set of matching entries, and a field 30 indicates the deletion of an entry.

Fields for recording information pertaining to users include a user code field 132, a user address field 134, an instruction field 136 and a field for an agent's address if the principal involved has selected an agent for post-matching negotiations. Finally, as indicated at 140 and 142, fields are provided for routing information and, optionally, for identifying an agent.

With reference to FIG. 4B, an active database table 144 contains all prospective transaction entries that are active, either because they were entered as active without any limits or contingencies, or because any limits or contingencies are presently met or have been satisfied. Pending entries are maintained in a database table 146. A table 148 contains all entries for which a contingency has not been met or a limit or condition is not satisfied.

Database tables relating to the fungible items include an item description table 150, a table 152 for item indication codes, and a table 154 for item pricing.

Database tables relating to system users include a table 156 listing the authorized users, a table 158 containing user identification codes, a table 160 including contact information provided by the users, and a table 162 containing user alert instructions. In addition, several tables are provided for use in auditing the system, including a table 164 of login events, an indication entry table 166 for the prospective transaction entries, a pair-off table 168 for recording the matches of entries, and a table 180 recording the deleted entries.

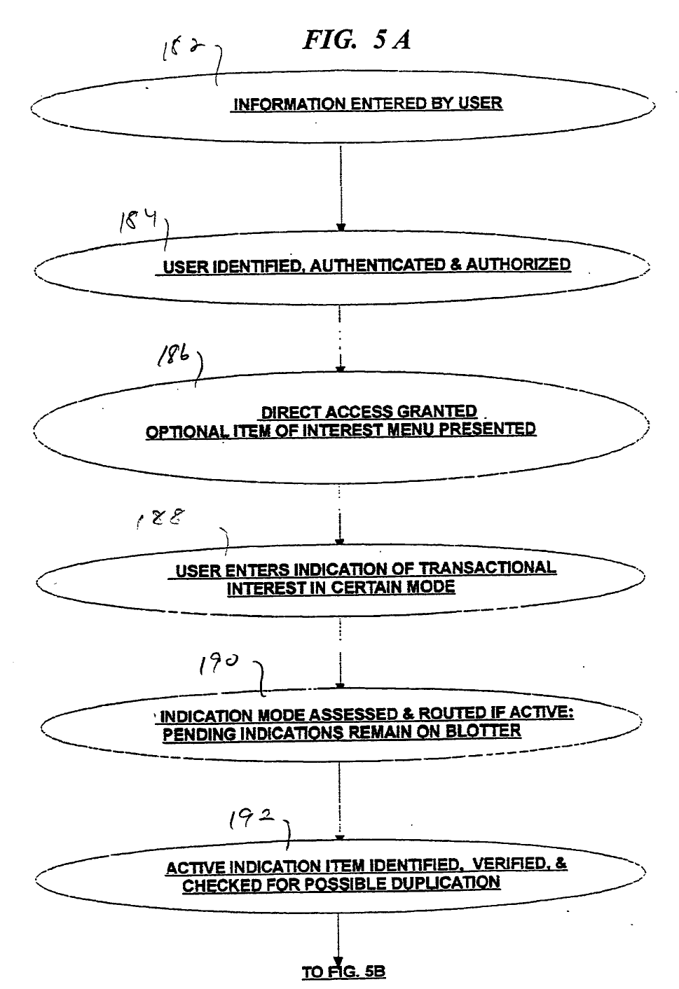

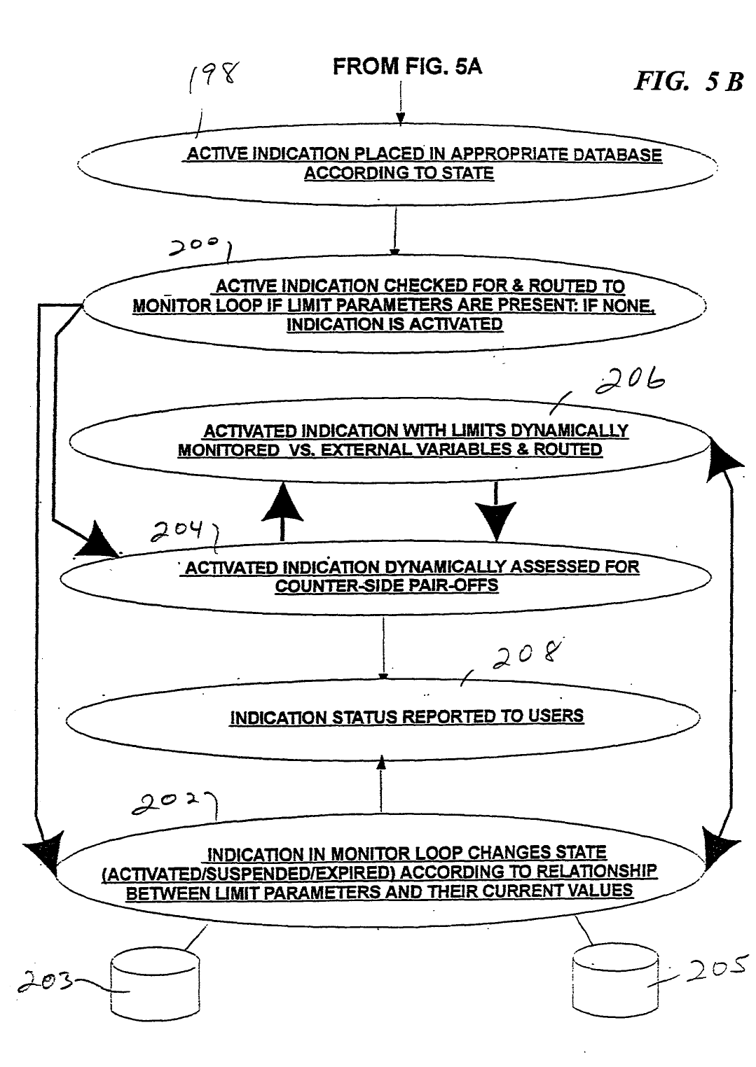

FIGS. 5A and 5B illustrate a flow chart highlighting the general operation of exemplary embodiments of the present system. Users enter their pre-authorized login information at 182 to gain access to the system. The system at 184 identifies the entity trying to access the system first through hardware and then if allowed via software security checkpoints (authentication and authorization). If identified and authorized, the user is granted access to the system at 186.

The user can choose a general area of transactional interest from a menu such as that presented here.

I. Collectibles

II. Securities

III. Commodities

IV. Merchandise

V. Agricultural Commodities

The user may also be presented with a series of related sub-menus to seek more specific items of interest. For example, collectibles may have the following sub-menus some of which may have further sub-menus which may themselves have further sub-menus:

I. Collectibles

A. Baseball cards;

B. Numismatic coins;

1. Pennies;*

2. Nickels;

3. Dimes; etc.

a. Boston mint;

b. Denver mint;

c. Philadelphia mint;

d. San Francisco mint; etc.

C. Philatelic stamps; etc.

Searches may be multi-layered, as well. In the above illustration, the specific year and grade quality of the penny of interest may be further specified.

The user at 188 enters one or more transactional interests pertaining to a particular item. Item identifying codes may be obtained from the database if not already known by the user. Point and shoot interface capabilities may also be used to find an item of interest out of a contextually specific, alphanumerically or graphically presented catalog of items of interest.

Indications of transactional interest can be entered in either of two modes: active or pending which are distinguished as:

Pending Mode: Entered but not yet submitted to system for potential matching with other transactional interest indications;

Active Mode: Entered and submitted to system for matching.

Indications entered by users in either active or pending mode are assessed and routed at 190. Pending indications are presented on the users' interface but go no further until put into active mode by the user. Pending indications later put into active mode by the user are shown as the newly active, and then follow the same path 192 for indications originally entered in active mode.

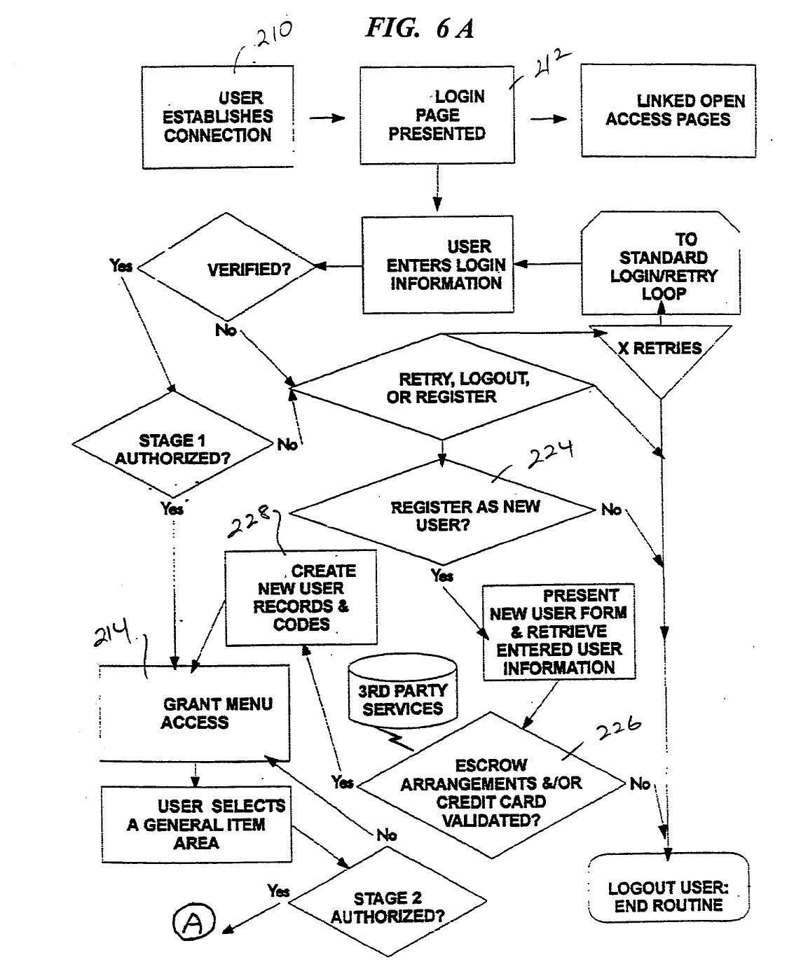

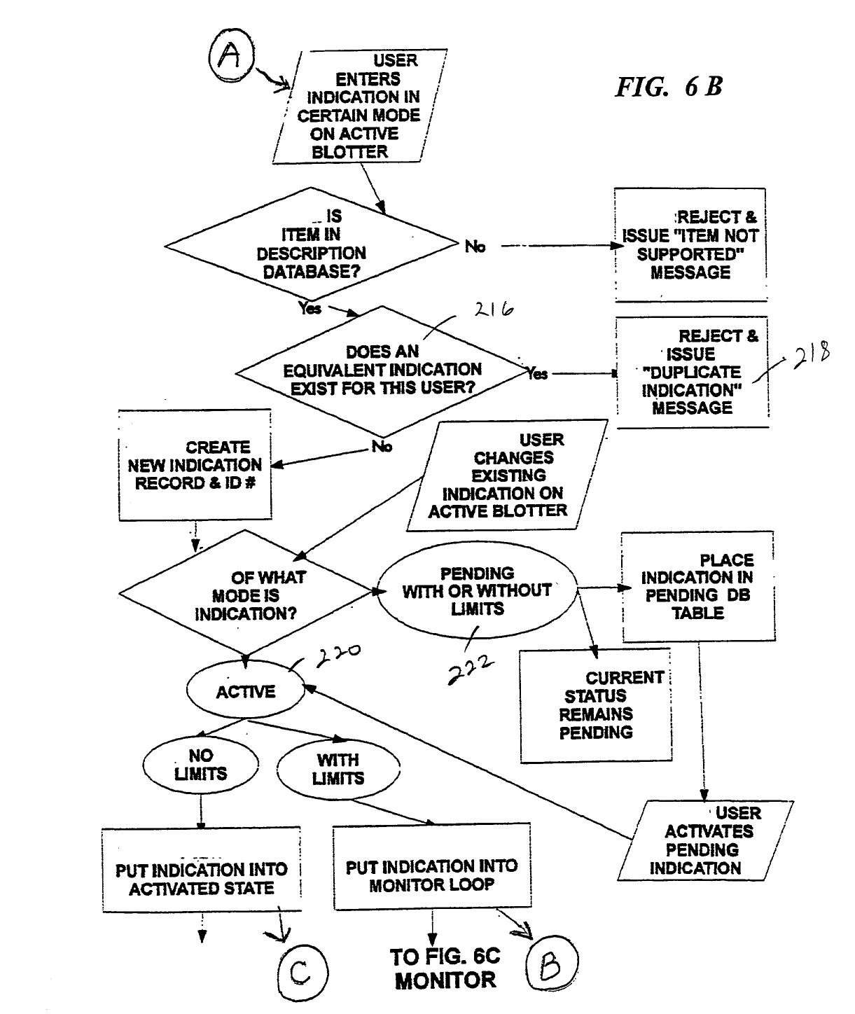

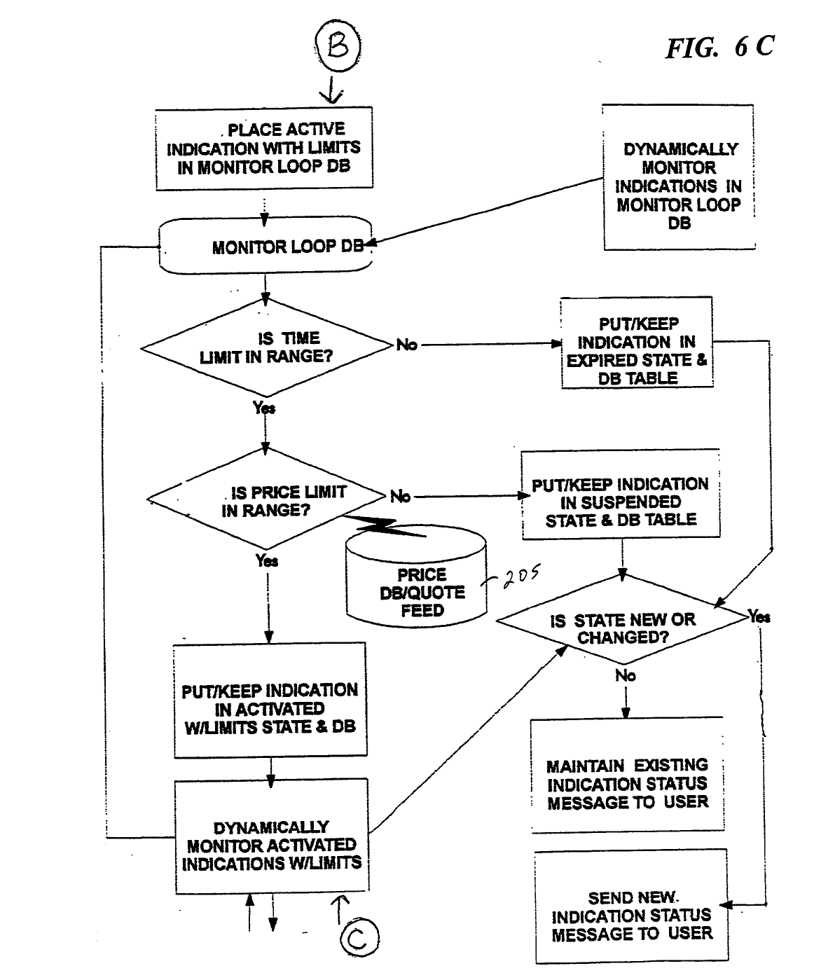

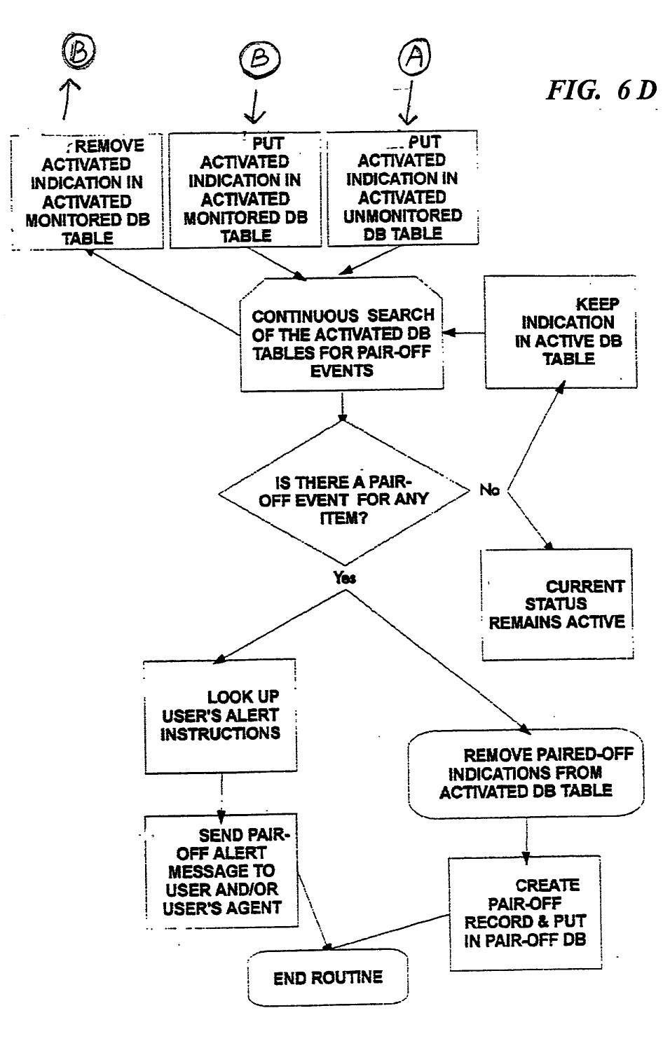

Once submitted in or changed to the active mode, the item of interest is identified and verified in the database. The user is afforded the further protection in that the system software runs a check for duplicate indication entry. See 196, and 216 and 218 (FIG. 6B). Once the item of interest is successfully verified and checked for duplication, the new active mode indication is passed on to the next step.

Next at 198, the active mode indication is sequentially assessed and placed by the system in the appropriate state and corresponding database.

Various States for submitted Transaction Interest Indications:

Activated: Indication is eligible to pair-off with one or more counter-side indications. Time has not expired.

With Limits; Monitored. The indication is eligible, and parameters or contingent factors are currently in-line with specified limit values. The indication is dynamically monitored with respect to the parameters or conditions for suspension and/or expiration.

Without Limits; Unmonitored. Eligible with no monitoring required.

Suspended: The interest is being monitored with at least one limit out of line. Time has not expired. Parameters or conditions (contingent factors) are currently out of line with specific values. Interest is dynamically monitored for re-activation.

Expired: Former active mode indication with time that has expired. De-activated because time value is outside of specified limits. Similar to Pending mode.

Deleted: Removed from system and blotter.

The new active mode indication is checked at 200 for the presence of limit parameters, and is either routed to the monitor loop 202 in a suspended state with limits that need to be checked, or is routed to the activated indication database 204 (without limits) if there are no limits.

The activated indication database is where indications in an activated state (whether monitored for limits or unmonitored) are continuously assessed for the presence of concurrent activated counter-side indications.

All newly entered active mode indications with limit parameters are automatically routed to the monitor loop 202 to check the limit parameters against current values for those parameters. These values typically are provided to the monitor loop from internal (e.g., time clock) 203 or external (e.g., pricing) 205 real-time or batch-refreshed data sources.

Thus, all indications entered in the monitor loop 202 are repeatedly assessed according to the relationship between their limit parameters and the current values of those parameters. As their states are changed, they are placed in the corresponding database by the system according to the current values related to their limit parameters. This process is repeated or looped, and indications are retained in or shifted to the “suspended” or the “activated with limits” states.

All activated indications with in-line limits and suspended indications (activated but with out-of-line limits) are dynamically monitored versus external variables in a monitor loop 206 and their states are changed according to current values. Newly arriving active indications with limits are immediately checked against the current limit values and are either put into an activated with limits state or remain in the suspended state for further monitoring.

Initial states and any changes to those states are dynamically reported to the user at 208 as status messages that reflect the dynamic assessments and place indications in the appropriate databases according to their states.

Use of the system is further understood with reference to FIGS. 6A-6D. When a potential user from a remote terminal first establishes a connection 210 with the central station, more particularly with the host communications server, the server presents a home page or login page 212 through which the prospective user enters login information. For already established users, this includes a user identification and password. If the information is verified and the user authorized, a menu is opened at 214 to enable the user to select an item to buy or sell. The user may identify the item with the required specificity initially, or make a general category selection and proceed through several stages of increasing specificity as described above in connection with numismatic coins. In either event, once the item-identifying code is entered, the user enters further information describing the transactional interest indication, e.g., the amount of the item, side of the transaction (buy or sell), and any applicable time limits. The completed transactional interest indication is compared to transactional interests already in the database at 216 (FIG. 6B). If an identical transactional interest is found, the prospective indication is rejected as a duplicate at 218. This protects the user from inadvertently entering the same indication twice.

If no duplication is found, the proposed transactional interest is monitored as to active or pending mode, then placed in the appropriate database or segment of memory at the secure central station, as either an “active” 220 or “pending” 222 interest indication. Pending entries remain pending until the user changes the status to active.

Active indications are further checked for the existence of limits. Interest indications with no limits are stored in the activated state. Active indications having limits are stored to a monitor loop where the limits or conditions of the indication are continually monitored, i.e., compared with internally generated or externally provided parameters.

FIG. 6C illustrates the monitoring function in which two parameters are involved, one internally generated (time) and the other externally provided (market price). As a result of this monitoring, the transactional interest indication is either maintained in an active state for potential pairing with other interests; suspended, indicating that the market price is outside of the specified limits; or expired, indicating that the time is beyond the specified limits. Conditions and limits other than price can be included in the transactional interest indication, and are handled in the same manner.

As shown in FIG. 6D, interest indications that either are active without limits or active with limits that are satisfied are continuously searched, i.e., compared with other interest indications for a potential synapse or pairing. The interest indication is maintained in the active state, unless a parameter changes leading to suspension or expiration, or a pairing occurs.

A pairing triggers two simultaneous actions: a message to the users involved in the pairing, and a removal of the matched interest indications from the activated segment of memory. A record of the synapse is created and maintained in the memory.

Returning to FIG. 6A, if a prospective user's login information is not verified, either initially or upon a predetermined number of retries, the prospective user is given an inquiry (224) regarding entry as a new user. A form is provided through which the prospective new user can enter information. Acceptance of a new user further may involve a credit card validation, escrow arrangement or other initial requirements to discourage or prevent users who lack the serious interest or capacity to engage in meaningful transactions, from proceeding further.

If appropriate, a new user at 226 is presented with surety and payment forms. These services are pre-arranged and made available from vendors by the system operators. The type of surety and escrow services required depends upon the user's declared general area(s) of interest and level of desired access. These services may be used to certify the security of the system by assuring the performance of users to each other prior to, and in the event of, a synapse event. Users may have to agree ahead of time to have a good faith deposit or earnest money automatically placed in escrow from a validated source of funds (typically a credit card) in order to access and use certain areas of the system. Users can be required to agree ahead of time to the forfeiture of the deposit in part or whole to the counter-party for failure to perform according to the rules after a synapse event.

Furthermore, in order to use the system under certain circumstances, users may have to agree ahead of time to rules that extend beyond those pertaining to the use of the actual system described herein. For example, individuals wishing to have access to the level where they can deal directly in certain items must agree in advance when registering for that level to use and pay for a clearing house function provided by an escrow agent appointed by the system operators to facilitate the payment and delivery process after a deal is consummated.

A fee for using the system may be charged at the registration point. This typically requires the user to enter credit card payment information for submission to the third party transaction processor for validation and approval. Of course, traditional financial transaction arrangements can be accommodated manually. The user is presented with an instructional page of other options and logged out if the financial arrangements are not validated.

A new user record (which includes modifications to existing records) is created at 228 with the associated user and authorization codes. The authorization code is determined when a user identifies an area of interest/level of access and is assigned when the attendant requirements are satisfied either through automatic or administrator mediated registration procedures.

The user is presented with a menu of general areas of interest organized by item type and access levels required to enter indications at 214.

The user at 230 enters a specific searchable item of interest or selects a general area of interest from the general interest menu page leading to a series of cascading menu pages terminating in a specific item of interest.

OPTION: Stage 2 Authorization: Access levels are required to enter indications for certain items of interest. These access levels are pre-assigned by the system administrator according to the various requirements listed in the user database. Authorization is either granted or denied. If granted the user is allowed to post an indication of interest. If denied the user is sent back to the home page.

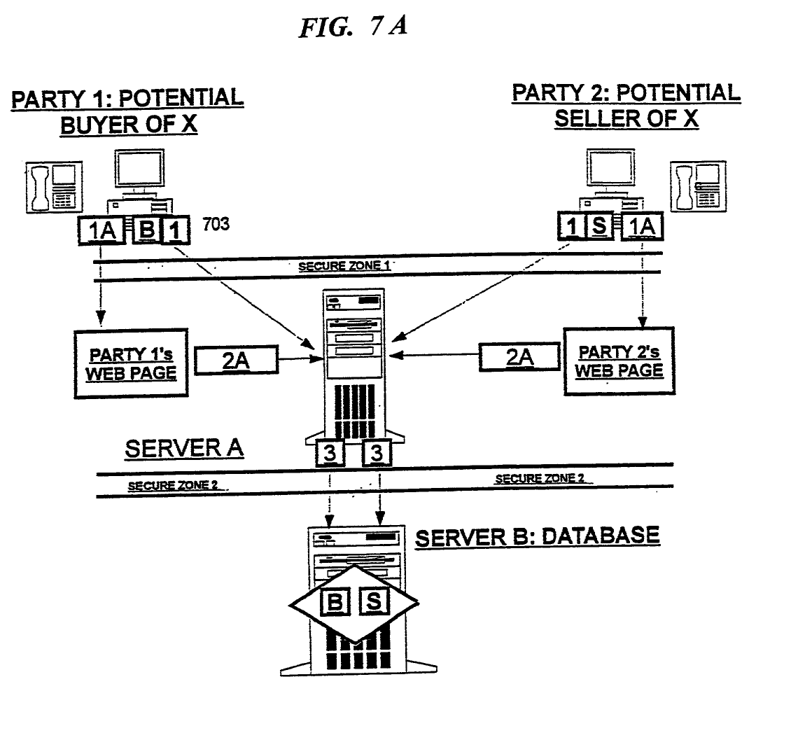

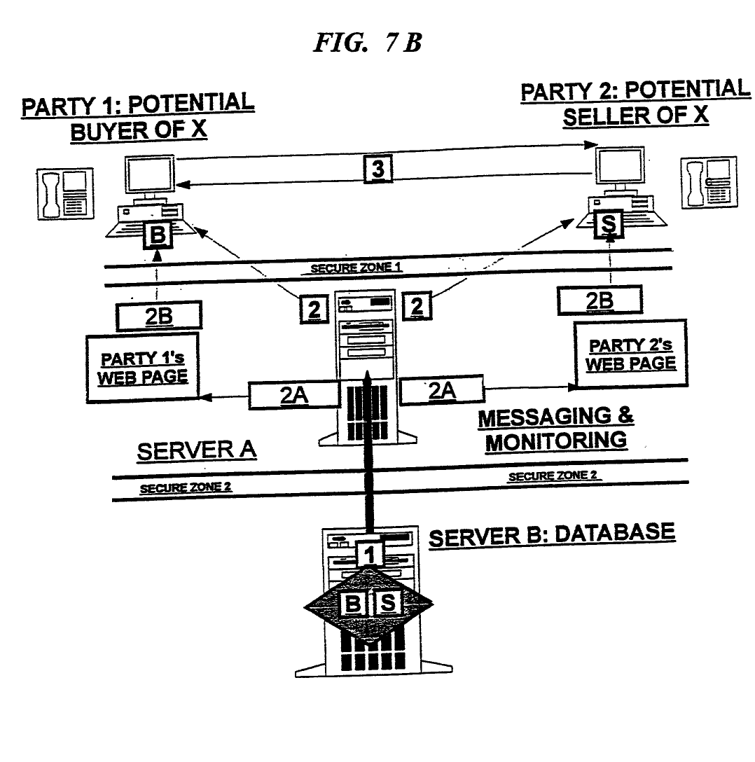

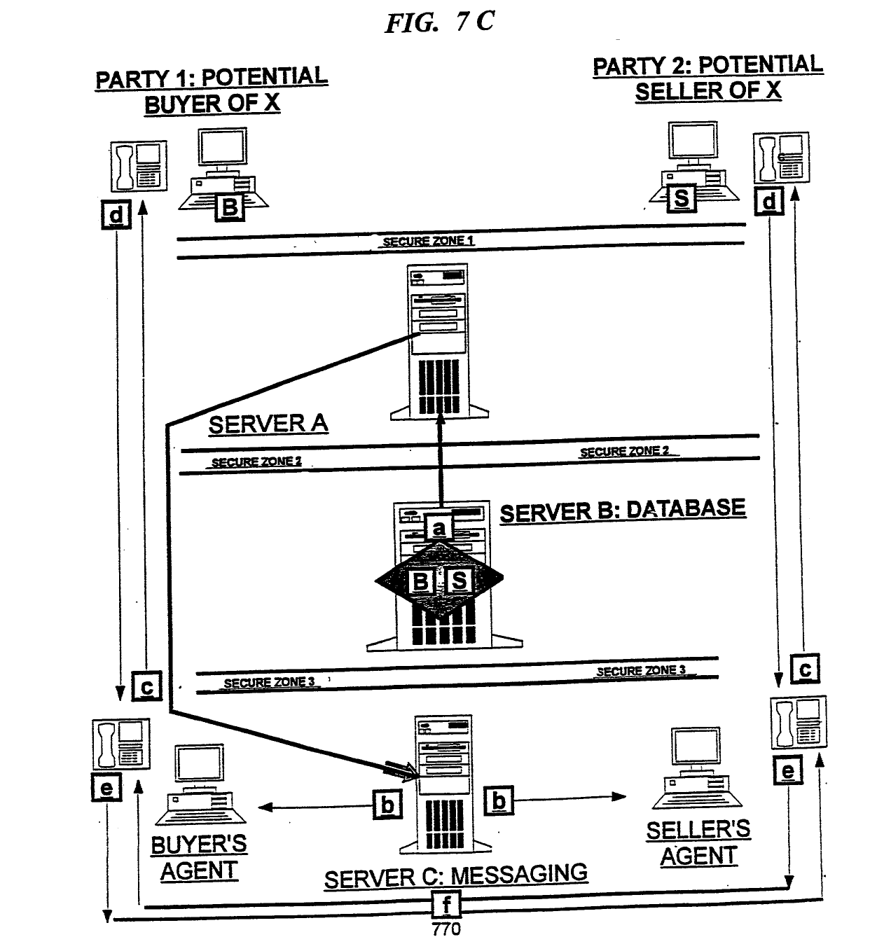

FIG. 7A illustrates a potential buyer and a potential seller of an item “X,” each entering a transactional interest indication. Each party enters its transactional information to the host communications server, either through a direct connection as indicated at 1, or through its web page as indicated at 1A followed by a transmission of the information to the server as indicated at 2A.

When each of the interest indications has been properly received by the communications server, it is transmitted to the database server as indicated at 3. In the database server, the processing explained above leads to the entry of the transactions into the segment of memory reflecting the active status of the entries, and a comparison leads to a synapse for pairing.

As seen in FIG. 7B, a message indicating the synapse is sent from the database server to the communications server, and then simultaneously transmitted (as at 2, or 2A plus 2B) to the transacting parties. The parties, simultaneously made aware of the match and of each other, are free to contact one another to complete the transaction, as indicated at 3. Even at this stage, no one except the transacting parties is aware of the respective offers to buy/sell item “X.”

With reference to FIG. 7C, if the transacting parties have designated respective agents, the synapse triggers the same message from the database server to the communications server. The communications server simultaneously transmits alerts to the buyer's agent and seller's agents, represented as step b in the figure. Each agent notifies its principal (step c), and receives instructions from its principal regarding the transaction. Finally, the agents contact one another (e, f) to complete the transaction. Again, at this stage, the nature of the transaction is known only to the transacting parties and their agents.

As an alternative to the procedure illustrated, the alert may be provided simultaneously to the transacting parties as well as their agents.

A further feature of this system concerns apportionment of the fungible commodity among several parties on the same transaction side. For example, suppose a synapse or match involves two buyers and three sellers, and that the prospective transaction entries of all parties have listed an amount of 300,000 shares, either to purchase or sell. Thus, 900,000 shares are proposed for sale, but the combined prospective purchase is for only 600,000 shares. The five parties negotiate within the confines of the lower amount on the buy side. In particular, the two buyers can each purchase 300,000 shares, while the three sellers each sell 200,000.

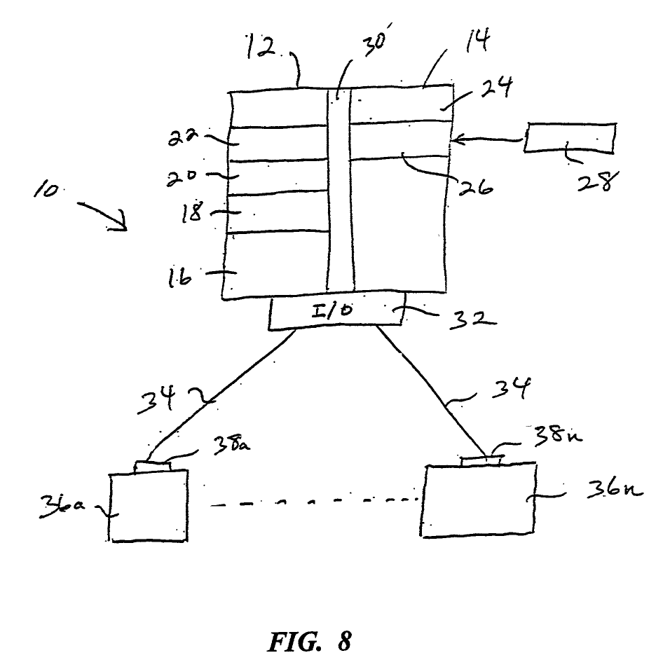

FIG. 8 illustrates the basic features of a system 10 constructed according to exemplary embodiments of the present invention. The system includes a secure central station 12 including a CPU and mass data storage capacity associated with the CPU. A memory 14 of the central station, typically including a computer's internal storage and peripheral storage units such as disk drives, is preferably organized into several memory segments including a segment 16 for storing relatively permanent data, i.e., not tied to a particular prospective transaction entry, a pending segment 18 for storing pending entries, i.e., transactional interest indications provided to the system but designated “pending” by users, an active segment 20 for storing active entries, and a suspended segment 22 for storing suspended entries. The memory further includes an internal parameter segment 24 containing internally generated parameters such as time, and an external parameters segment 26 for receiving information from external sources such as a source 28 of market price information.

Memory segment 16 contains information about individual transactors, such as name, address, telephone numbers and passwords.

The various memory segments are operationally associated with one another by information management and operations programs that reside in the CPU, as indicated at 30.

A communications or I/O port 32 of the CPU governs communications with a network 34 linking remote terminals with the central station. Two of the remote terminals are indicated at 36a and 36n, with respective communications (I/O) ports 38a and 38n that communicate with port 32 according to a common communications protocol.

The system can be further understood in accordance with an example based on trading equities (securities) in large amounts such as those associated with institutional trading.

The system is based on a network with a secure central station coupled via inter/intra/direct connections to remote stations used by parties to enter transaction interest information and receive alerts. Use of the application and system is illustrated below using equity securities as the item of transactional interest for example.

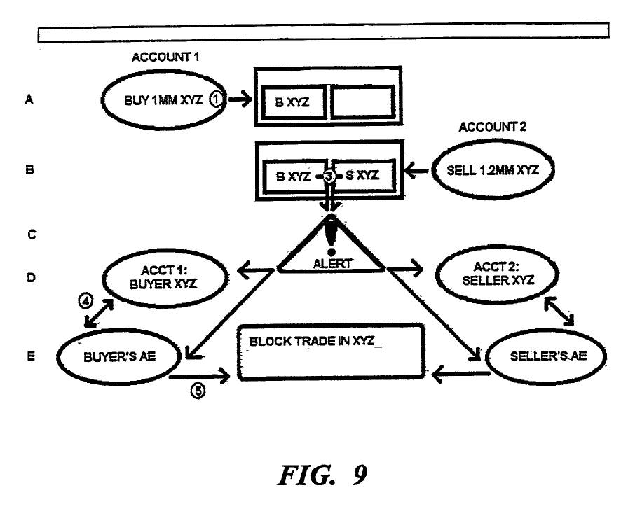

Further examples of items where this invention could work may be found anywhere a buyer and seller of any given item are seeking to find one another. Such items of transaction interest may be found in real estate; wholesaling; corporate purchasing; fine art; collectibles; stamps; coins; bullion; antiques; automobiles; automobile parts, aircraft and aircraft parts, financial securities; commodities; and derivatives. The following explanation of system logic is best understood in conjunction with FIG. 9 featuring steps A-E.

At step A, a trader at account 1 enters a “buy” indication into the system. The indication consists of side & security. Traders enter indications from their terminals. The communication link can be of any variety**. The central station is a secured facility protected by firewalls, secure socket layers and high grade encryption. Nothing takes place unless, at step B, a trader at account 2 enters a “sell” indication into the system. At this point, at step C, the “sell” indication of the trader at account 2 is paired off with the “buy” indication from the trader at account 1. This pairing indicates that a synapse has occurred. Synapses are made and known only be the computer. Then, and only then, are the transaction interests of both parties disclosed and then only to the parties. Alerts (with contact information) are simultaneously sent only to the parties involved and to their agents, if agents have been retained by either of the parties. Each party now knows that it has a confidential natural contra-side to its trading interest. Henceforth, at step E, the natural contra-sides contact one another to begin negotiations which leads to a completely confidential negotiated transaction between only the qualified parties.

No information concerning either party's indication is revealed until there is a synapse between qualified contra-parties. Then, the only entities who are alerted are the matched accounts and/or their designated agents. A minimum commitment or a good faith deposit may be required to enter the system. This is meant to keep information seekers out, to ascertain that the other side is real and to make sure that a real negotiation takes place following a synapse.

Each party can enter a transactional interest or indication including item, identity and side (buyer or seller). The indication can be withdrawn from the system at any time. Current price monitoring is the responsibility of each entering party.

Meanwhile, other parties are using the system to enter similar information. None of the individual entries is broadcast. Instead, the secure central station compares entries to find a synapse (or coincidence event) involving a buyer and a seller (or perhaps more than one of either) of the same item.

When a synapse occurs, all matched buyers and sellers (or their appointed agents) are informed simultaneously that a synapse has occurred. Up to this point, none of the parties knows the identity of the other party (or parties) involved. When a synapse occurs, the contra-parties (or their agents) are put in communication with one another. The transaction is then negotiated between the matched parties or their agents.

There are manifold ways to consummate a deal once interested contra-parties are matched in transactional interest. However, it is not the purpose of this system to negotiate, consummate, or execute a deal. Current mechanisms adequately allow contra-parties to consummate and, if necessary, report a transaction. This system is not an execution system. It is an information management system allowing interested parties to securely find one another prior to any negotiations leading to a transaction.

To qualify, the size must be a certain minimum based on liquidity of the stock involved (e.g., 100,000 shares). The trader also may enter an acceptable price range, and the time that the offer will remain in force.

The above-described exemplary embodiment of the present invention has the following features and advantages. It enables principals to anonymously enter their transactional interest in buying or selling any item into a secure centralized computer networked facility. This protects the transaction interests of any potential contra-sides to a mutually desired transaction before these interests are disclosed to either side and more importantly, without disclosing this information to anyone. The system protects the transactional interests of interested contra-parties to a potential transaction prior to any disclosure of that interest. Once entered, these transactional interests have the potential of being matched with natural contra-parties to their interests—without any disclosure of these proprietary transactional interests to any other party. The contra-party transactional interests are matched in secrecy. The system alerts qualified parties (or their designated agents) ONLY when each has a qualified party matched on the contra-side to their transactional interest. Only matched parties of a mutually desired transaction (or their agents) are alerted in confidence. Qualified parties (or their designated agents) are alerted ONLY when each has a qualified party matched on the contra-side to their transactional interest. When a match occurs, the matched parties with contra-side transactional interests will be confidentially alerted and given each other's contact information according to a prior agreed upon protocol. Negotiations will then ensue directly with one another (or via agent(s)) in a traditional manner. All potential participants are pre-qualified by requiring each to make a minimum firm commitment prior to being allowed to enter a transactional interest into the system. This may entail posting a non-performance penalty bond or earnest money deposit which shall go to the contra-party to a synapse if the other party fails to perform (enter into negotiations) after a synapse.

Thus, in accordance with exemplary embodiments of the present invention, a system is provided that enables parties dealing in fungible commodities can seek counter-parties to their proposed transactions in a secure environment that maintains their anonymity until the prospective transaction entries of two or more parties are matched. Following the match, only the involved parties are notified. The matching or coincidence event does not determine the details of a purchase and sale, or other transaction. Instead, within the confines of price ranges or other conditions provided as part of the matching entries, the matched parties negotiate the unresolved specifics of the transaction. The anonymity prior to a match, together with standards that qualify potential users to provide prospective transaction entries to the secure station, preserve the value that inures to each party from maintaining the secrecy of its transactional interests. Parties have the flexibility to tailor their prospective transaction entries by incorporating time limits, price limits and other contingencies. Parties are further encouraged to use the system as a match of several parties does not rigidly determine all terms of the transaction; instead, the system sets the stage for the parties to negotiate.

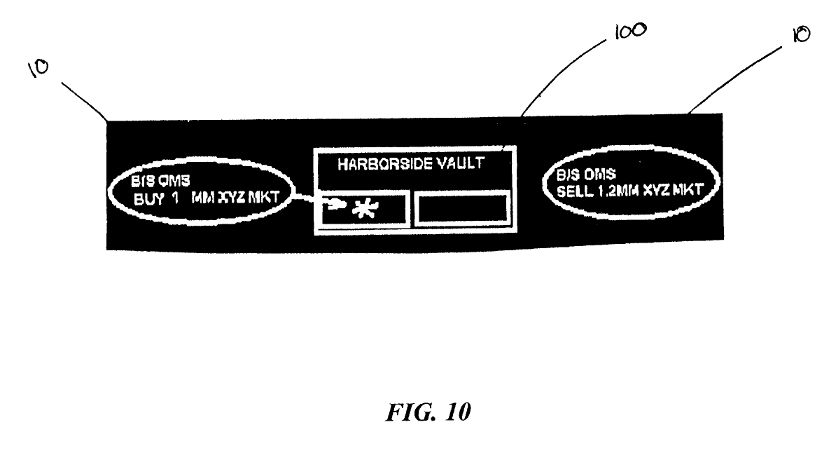

FIG. 10 illustrates a block diagram of an information management system according to exemplary embodiments of the present invention which comprises a plurality of remote stations 5 as well as a central database 1, also referred to as the “vault”. This database 1 is preferably a secure, centralized computer networked facility. This security may be provided through the use of firewalls, secure socket layers, or weapons grade encryption techniques, for example. The central database 1 is coupled to each remote station 5 via the internet, an intranet, wide area network, a third party information carrier (such as through a Bloomberg terminal), dial in access, a direct connection or other similar method. The remote stations 5 are used by potential buyers and sellers to enter their transactional interest indications into the database 1 and to receive alerts from the system.

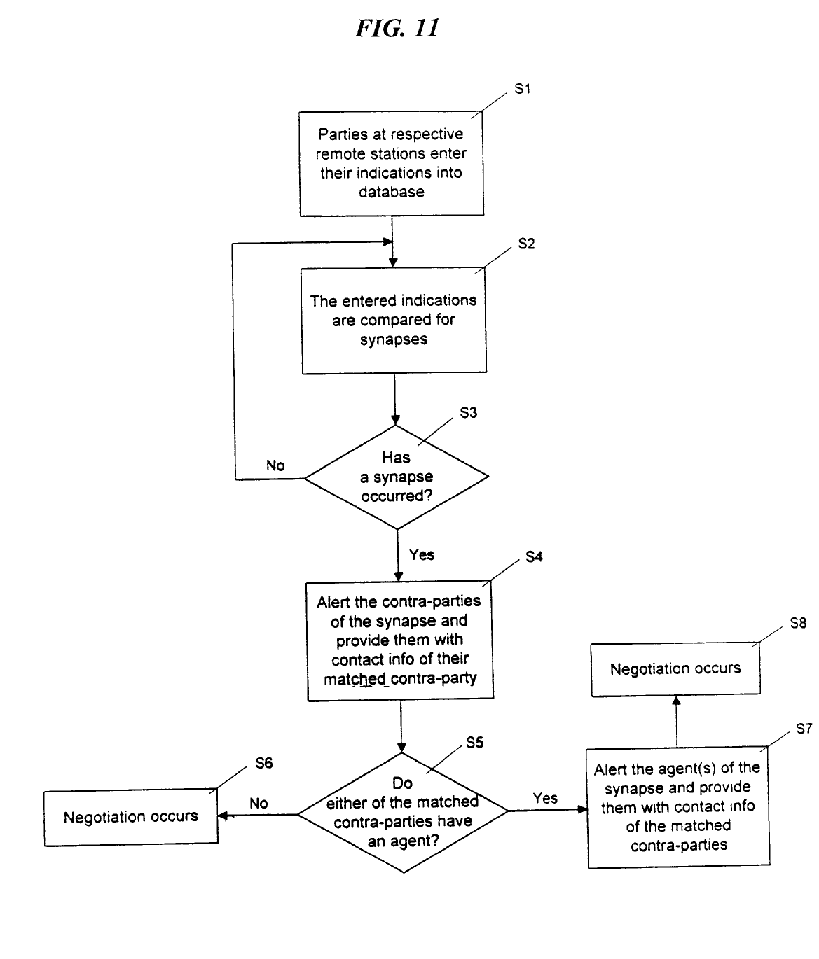

FIG. 11 illustrates a flow diagram of a method according to an exemplary embodiment of the present invention. At step S1, each party enters their respective transactional interest indications into the database 1 via respective remote stations 5. Once entered into the database 1, these transactional interests have the potential of being matched with contra parties to their interests. At step S2, the information management system then searches the database 1 for a match (also known as a “synapse”) between the respective indications that have been entered into the database by various parties in step S1. If it is determined in step S3 that a synapse has occurred between any of the entered indications, the contra-parties of the synapse are alerted and the broker of each contraparty is provided the contact information of the other contra-party's broker in step S4. If it is determined in step S3 that no synapse has yet occurred between any of the entered indications, the flow returns to step S2 to continue to compare entered indications for a match.

An alternative to the above-described arrangement would simultaneously alert the matched contra-parties and any authorized representatives or agents of the synapse along with the associated contact information, or in cases where a contra-party does not have an authorized representative, to notify and provide contact information only to the contra-party. Once the matched contra-parties and any authorized representatives are provided with the associated contact information, negotiation may commence in step S8. On the other hand, if a determination is made in step S5 that neither of the matched contra-parties have authorized representatives or agents, negotiation will commence between only the matched contra-parties in step S6.

Accordingly, only the “interested” parties and/or their respective agents, representatives, or account executives are notified so that negotiations between the matched parties can occur. In other words, the transactional interests are matched in secrecy. The trading details and the fact that a match occurred are not disclosed to third parties. The matched parties (and/or their respective agents) are then given each other's contact information according to a prior agreed upon protocol. In a preferred exemplary embodiment of the present invention, a party is only notified that an active contra party to their transactional interest exists and that negotiations of actual size and price are to commence.

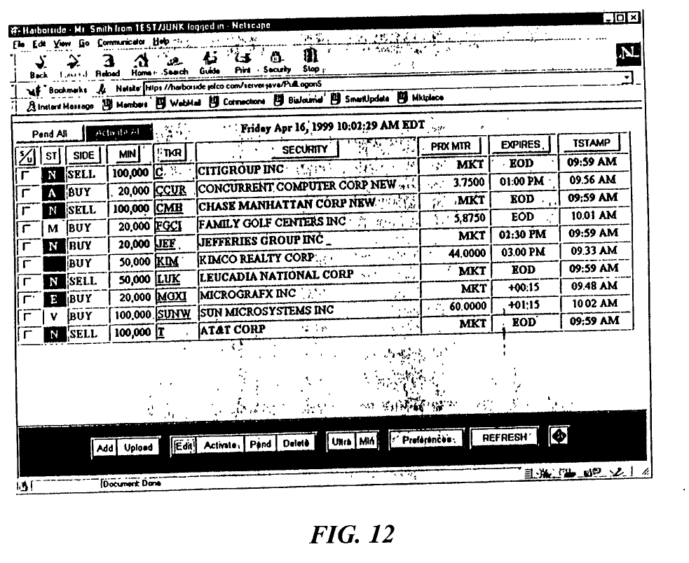

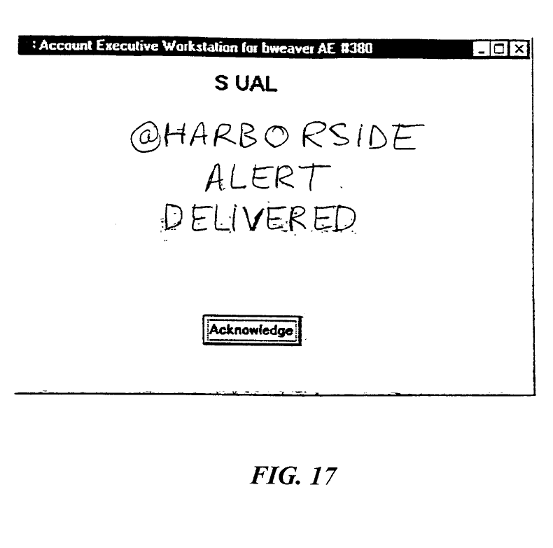

On the party's main summary screen, as illustrated in FIG. 12, the status indication in the status column (ST) will change to “N” to indicate a negotiation phase. Respective account executives and/or agents are notified that a contra party exists with a pop-up alert screen, as shown in FIG. 17, if they are to be involved in the particular transaction. This alert provides the account executive with their customer's identifier, the side, the ticker symbol and the customer identifier of the contra party. The account executives, agents and matched parties are then able to contact each other and negotiate the final details of their transaction.

In an exemplary embodiment of the present invention, a party enters a secure web site with a user name and password via an Internet browser. Once in the system, the main screen displays that particular party's currently stored trading indication information, as shown in FIG. 12. This screen is also referred to as the system blotter screen. The embodiment illustrated in FIG. 12 is directed to a system for trading equity securities. This screen displays the status (ST) of each indication of that party, its side (for example, whether the party is a buyer or seller), the minimum amount of the shares for sale or purchase (MIN), a ticker symbol (TKR), a company name (SECURITY), an acceptable price range (PRX MTR), cancel time (the time that the indication of interest will expire) (EXPIRES), and a time stamp (TSTAMP). The possible status indications (ST) that may appear in the second column of FIG. 12 are as shown in the following chart.

| | |
|---|---|
| Pending (P) | An indication has been entered on the system |
| | blotter but not yet activated for matching |
| Verifying (V) | A verification of the price monitor versus the |
| | current market |
| Active (A) | An indication is active and available for |
| | matching |
| Negotiate (N) | A match exists and negotiation is in progress |
| Monitor (M) | An indication exceeds the market limit price |
| | and is temporarily suspended |
| Expired (B) | The time-in-force has been exceeded |
| Rejected (R) | An indication has been rejected and is not |
| | active |

From the main summary screen shown in FIG. 12, a party can enter, activate, edit, or delete any of their stored indications.

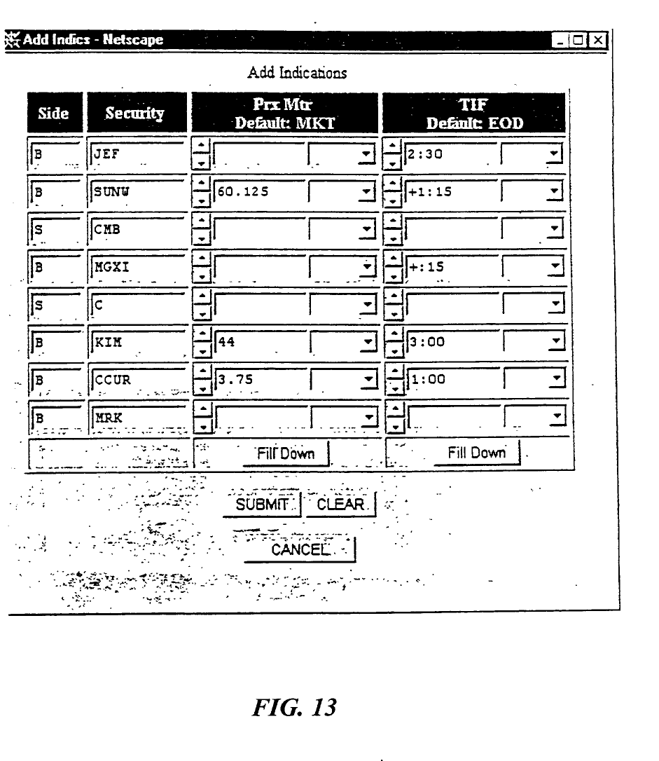

The respective indications of interest of each party can be entered into the database 1 of the information management system in a variety of ways. For example, the individual indications can be entered from a standard web based front-end application. By clicking the ADD button on the blotter screen of FIG. 12, the screen shown in FIG. 13 will be displayed to the party so that their indications can be entered to the system. This standard web application can also be used to load lists of the party's indications. To make the system as easy as possible to use, the indication requirements of the system may be directly integrated with one or more of any of the available buy side order management systems (OMS) including the MacGregor Group's Preditor System, the Landmark's Longview System, and the Merrin Financial Group's Windows and Order Management Systems. The party can highlight indications of interest by pointing and clicking on the OMS's blotter and creating an export file to send and upload orders directly to the information management system of the present invention via the Financial Information Exchange (F.I.X.) protocol. The F.I.X. protocol is an industry standard protocol being used for the electronic delivery of indications of interest, orders, execution reports, and allocations.

Using the standard web based front-end application referred to above, the party selects the NEW button on the summary screen and the screen shown in FIG. 13 appears. This screen includes the following headers: Side, Security, Prx Mtr, and TIF. The party is only required to fill in their side and security indications. However, the party can also enter a limit price into the price monitor column (Prx Mtr). This is the limit price where the indication becomes suspended.

The party may also enter a time-in-force restriction (TIF). This is the time that their indication will expire. When the entry of these indications to this screen is completed, the party selects a SUBMIT button displayed on the screen to enter the indications into the information management system with a PENDING status.

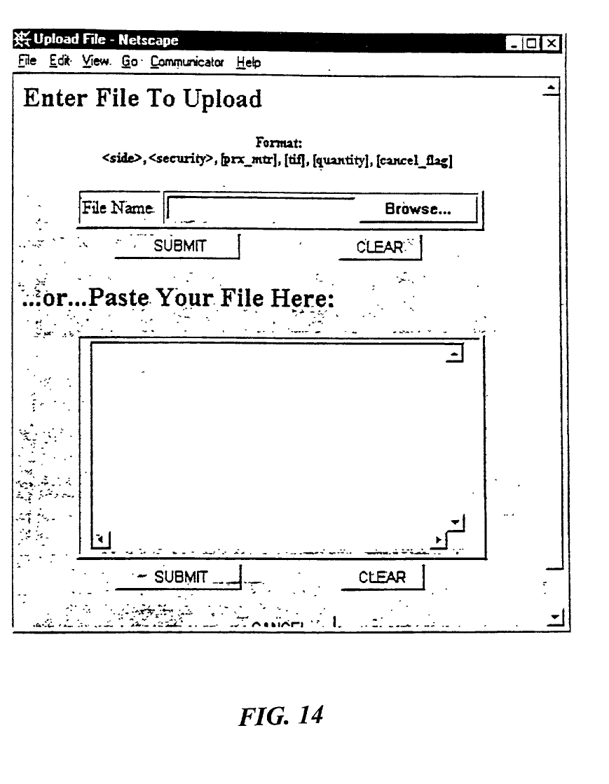

It is possible for the party to enter a list of their indications for one or more desired transactions from the standard web application into the system database 1. To do this, the party selects the UPLOAD button of the web application. The screen shown in FIG. 14 will then be displayed by the information management system. This screen allows the party to input a list of securities for entry into the system database 1. Alternatively, the party can specify a file name and path for automatic upload into the system database 1. The party can also CUT data from any available software packages such as Excel, Word, Notepad, etc., for example. Once this data is CUT, it can be pasted using the PASTE feature of these packages directly into the File Upload Screen of the information management system of the present invention that is shown in FIG. 14.

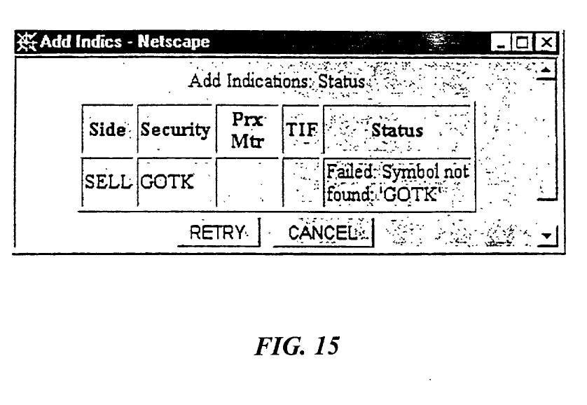

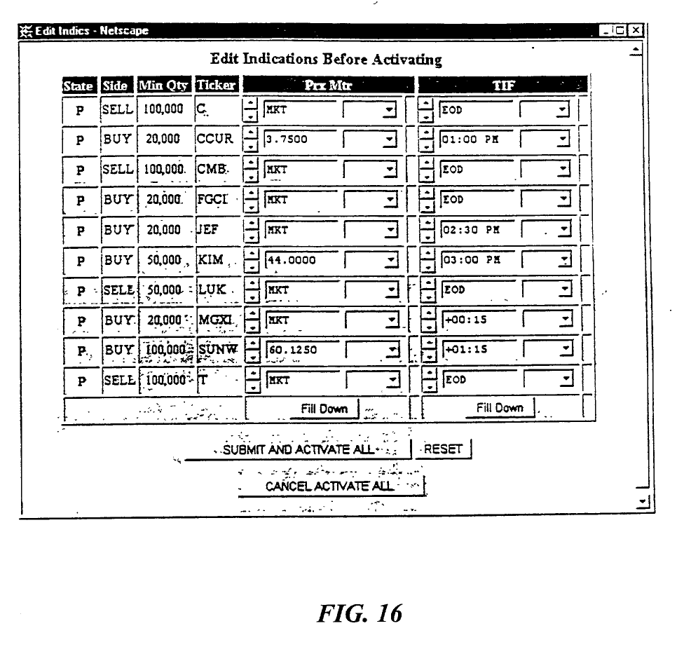

Once the list containing the party's indication information is entered to the File Upload Screen, the party selects the SUBMIT button on that screen to submit the indication information to the system database 1. The system will validate any input ticker symbols and will display the screen shown in FIG. 15 if an invalid ticker symbol is detected. Once the indication information has been stored in the system database 1, the party's main summary screen shown in FIG. 12 is once again displayed to the party. The summary screen now displays the minimum size required for submission. The party may now select any of their stored indications that they wish to activate and then select the displayed ACTIVATE button on the summary screen. The system then displays the screen shown in FIG. 16 that allows the party to edit any of their indications to be activated. It also displays the minimum share amount, for example, for trading.

When the party selects the SUBMIT AND ACTIVATE ALL button displayed on the screen shown in FIG. 16, the orders are sent to the system database 1 and the status for those particular indications are changed to ACTIVE (“A”). Once active in the database 1, the information management system searches other stored indication information in the database 1 for contra matches of order requests. For example, the database searches for a buyer's indication information that will match the indication details of a particular seller. More particularly, the search algorithm of an embodiment of the present invention operates as follows. When a new indication enters the information management system, the system searches all ACTIVE (“A”) indications for a match. All contra indications are notified simultaneously regardless of the time entered. In this embodiment, sizes and prices are not entered by the parties, except for limit prices for cancellation. If an order exceeds its limit, it is assigned a status of MONITOR (“M”) and is not eligible for matching. There is no hierarchy for the match. All parties are treated equally in that respect.

The parties with matched transactional indication interests are termed “contra-parties” or “contra-side parties”, meaning a buyer for a seller or a seller for a buyer, for example. Once this match occurs, the information management system alerts the contra-parties and/or their respective account executives (AE's) and agents. On each of the contra parties summary screens, the status of that particular matched indication will change to NEGOTIATE (“N”). If account executives are to be alerted, they will receive the alert screen shown in FIG. 17 and will be prompted to acknowledge the match by selecting the displayed “ACKNOWLEDGE” button.

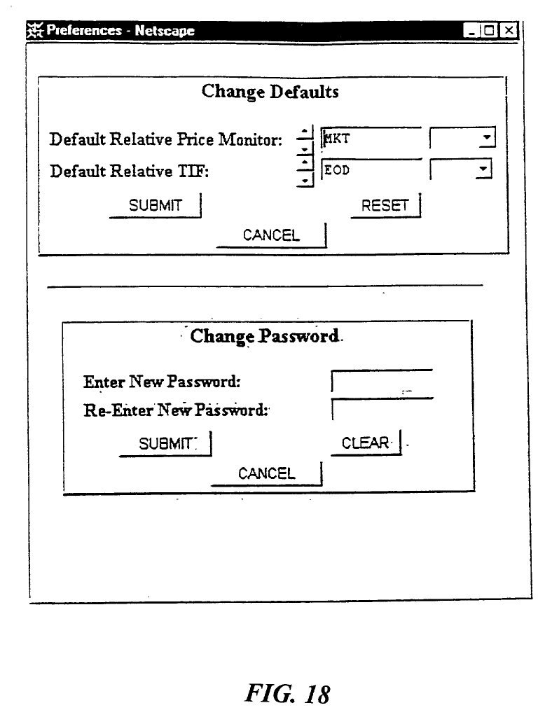

FIG. 18 shows an optional screen for the information management system that allows a party to change their default settings for price amount and indication expiration time. The screen also allows a party to change their password used to access the system.

Accordingly, the information management system of the present invention overcomes many of the problems and inefficiencies of prior information management systems by providing a confidential, secure system for finding, matching and alerting qualified contra parties to a mutually desired negotiation. The system of the present invention is not an execution system as discussed in the Background of the Invention above. Instead, it is an information management system that utilizes a combination of computer mediated information management and secure network communications to provide a new way to identify and bring together parties interested in negotiating a transaction while at the same time protecting their transactional interests before a contra side to their interest is identified.

The system of the present invention identifies the contra parties to a negotiation in a completely confidential environment. The contra parties are introduced to each other so that they, along with their agents if desired, can negotiate to consummate the deal in a completely confidential environment without third parties being aware of their dealings or even their initial transactional indication requests.

In accordance with the principles of the present invention, no information concerning either party's trading indications is revealed until there is a synapse in the system between qualified contra parties. While multiple parties may be entering transactional information at any time, none of the individual entries will be publicly broadcast. Instead, the secure central database station compares the entries to find a synapse between a buyer and a seller of the same item. The station may also look to find more than one of either the synapse or the coincidence event.

In one embodiment of the present invention, upon the occurrence of a synapse, all matched buyers and sellers are simultaneously informed that a synapse has occurred. The notice provided by the present invention presents the opportunity to negotiate for the transfer of a larger number of shares, at the same or a different price, again as a private matter between or among the parties involved.

It will be apparent to those skilled in the art that various modifications and variations can be made in the improved promotional financial transaction machine method of the present invention without departing from the spirit or scope of the invention.

For example, a pre-qualification step may be added that requires all parties to make a minimum firm commitment or good faith deposit prior to being allowed to enter a transactional interest into the system. This may, for example, entail a non-performance penalty bond or earnest money deposit which shall go to the contra party to a synapse if the other party fails to perform after a synapse occurs. This step would help to keep non-interested information seekers away from the system and to assure that each contra party is a natural contra party to the transaction to be negotiated.

Moreover, while the above described embodiment sets forth an Internet-based information management system, the communications link can be of any variety that would be known to the artisan including a direct wire installation.

While the above described embodiment describes a system using securities as the item of transactional interest, the artisan will appreciate that the concepts of the present invention disclosed above are also applicable to a wide variety of applications where a buyer and seller wish to be introduced so that they may enter into negotiations with each other. Such areas include real estate, wholesaling, corporate purchasing, fine art, collectibles, stamps, coins, bullion, antiques, automobiles, other types of financial securities, commodities, and derivatives, for example.

It will be apparent to those skilled in the art that various modifications and variations can be made in the method and system for facilitating secure transactions of the present invention without departing from the spirit and scope of the invention. Thus, it is intended that the present invention cover the modifications and variations of this invention provided they come within the scope of the appended claims and their equivalents.

What is claimed is:

1. A method for anonymously and confidentially identifying contraparties to transaction and notifying an authorized representative of the contraparties to contact the contraparties in order to negotiate a transaction, comprising the steps of:
receiving indications of interest from potential buyers and potential sellers into a central processing system, each indication of interest involving a purchase or sale of a specific item;
anonymously comparing indications of interest received from potential buyers with indications of interest received from potential sellers within the central processing system to determine whether a match has occurred;
identifying contraparties to a transaction based on said determination of whether a match has occurred;
notifying the authorized representative of the contraparties that a match has occurred;
providing contact information to the authorized representative to allow the authorized representative to contact the contraparties so that a transaction can be negotiated between the contraparties; and
consummating the transaction between the contraparties through direct negotiation between the authorized representative and the contraparties.

2. The method of claim 1, wherein at least one of the received indications of interest involves the purchase or sale of an equity security.

3. The method of claim 1, wherein at least one of the received indications of interest involves the purchase or sale of a debt security.

4. The method of claim 1, wherein at least one of the received indications of interest involves the purchase or sale of a derivative security.

5. The method of claim 1, wherein at least one of the received indications of interest contains a limit as to the acceptable price per unit of the specific item that is the subject of its associated transaction.

6. The method of claim 1, wherein at least one of the received indications of interest contains a limit as to the minimum acceptable total value of its associated transaction.

7. The method of claim 1, wherein at least one of the received indications of interest contains a limit as to the minimum acceptable number of units to be purchased or sold in connection with a transaction.

8. The method of claim 1, wherein at least one of the received indications of interest includes ancillary information not used in determining whether a match has occurred in said comparing step but which is transmitted to a matched contraparty during said consummating the transaction step to assist in negotiations between the contraparties.

9. The method of claim 5, wherein a match between a potential buyer and a potential seller is not determined to have occurred in said comparing step unless any price per unit limits established by each of the potential buyer and the potential seller are satisfied.

10. The method of claim 6, wherein a match between a potential buyer and a potential seller is not determined to have occurred in said comparing step unless any minimum acceptable total values of the transaction established by each of the potential buyer and the potential seller, respectively, are satisfied.

11. The method of claim 7, wherein a match between a potential buyer and a potential seller is not determined to have occurred in said comparing step unless any minimum acceptable number of units established by each of the potential buyer and the potential seller, respectively, is satisfied.

12. The method of claim 1, wherein said providing step also includes providing contact information directly to the contraparties.

13. The method of claim 1, wherein a match is not determined to have occurred between a potential buyer and a potential seller in said comparing step unless all input fields making up the indication of interest entered by the potential buyer matches all input fields making up the indication of interest entered by the potential seller.

14. The method of claim 1, wherein a match is determined to have occurred between a potential buyer and a potential seller in said comparing step even though all input fields making up the indication of interest entered by the potential buyer do not match all input fields making up the indication of interest entered by the potential seller.

15. The method of claim 1, wherein an indication of interest from a potential buyer is not received into the central processing system unless the potential buyer makes a good faith deposit.

16. The method of claim 1, wherein an indication of interest from a potential seller is not received into the central processing system unless the potential seller makes a minimum firm commitment.

17. The method of claim 1, further comprising the step of reporting the consummation and terms of the transaction to the central processing system.

18. A method for anonymously and confidentially identifying contraparties to a transaction and introducing authorized representatives of each respective contraparty to each other in order for the authorized representatives to negotiate a transaction, comprising the steps of:
receiving indications of interest from potential buyers and potential sellers into a central processing system, each indication of interest involving a purchase or sale of a specific item;
anonymously comparing indications of interest received from potential buyers with indications of interest from potential sellers within the central processing system to determine whether a match has occurred;
identifying contraparties to a transaction based on said determination of whether a match has occurred;
notifying the contraparties and their respective authorized representatives that a match has occurred;
providing contact information to each of the authorized representatives to allow the authorized representatives of the contraparties to contact each other so that a transaction can be negotiated between the contraparties; and
consummating the transaction between the contraparties through direct negotiation between the authorized representatives of the contraparties.

19. The method of claim 18, wherein at least one of the received indications of interest involves the purchase or sale of an equity security.

20. The method of claim 18, wherein at least one of the received indications of interest involves the purchase or sale of a debt security.

21. The method of claim 18, wherein at least one of the received indications of interest involves the purchase or sale of a derivative security.

22. The method of claim 18, wherein at least one of the received indications of interest contains a limit as to the acceptable price per unit of the specific item that is the subject of its associated transaction.

23. The method of claim 18, wherein at least one of the received indications of interest contains a limit as to the minimum acceptable total value of its associated transaction.

24. The method of claim 18, at least one of the received indications of interest contains a limit as to the minimum acceptable number of units to be purchased or sold in connection with a transaction.

25. The method of claim 18, wherein at least one of the received indications of interest includes ancillary information not used in determining whether a match has occurred in said comparing step but which is transmitted to the authorized representatives during said consummating the transaction step to assist in negotiations between the contraparties.

26. The method of claim 22, wherein a match between a potential buyer and a potential seller is not determined to have occurred in said comparing step unless any price per unit limits established by each of the potential buyer and the potential seller are satisfied.

27. The method of claim 23, wherein a match between a potential buyer and a potential seller is not determined to have occurred in said comparing step unless any minimum acceptable total values of the transaction established by each of the potential buyer and the potential seller, respectively, are satisfied.

28. The method of claim 24, wherein a match between a potential buyer and a potential seller is not determined to have occurred in said comparing step unless any minimum acceptable number of units established by each of the potential buyer and the potential seller, respectively, is satisfied.

29. The method of claim 18, wherein contact information for the authorized representatives are also disclosed directly to the respective contraparties in said providing step.

30. The method of claim 18, wherein a match is not determined to have occurred between a potential buyer and a potential seller in said comparing step unless all input fields making up the indication of interest entered by the potential buyer matches all input fields making up the indication of interest entered by the potential seller.

31. The method of claim 18, wherein a match is determined to have occurred between a potential buyer and a potential seller in said comparing step even though all input fields making up the indication of interest entered by the potential buyer do not match all input fields making up the indication of interest entered by the potential seller.

32. The method of claim 18, wherein an indication of interest from a potential buyer is not received into the central processing system unless the potential buyer makes a good faith deposit.

33. The method of claim 18, wherein an indication of interest from a potential seller is not received into the central processing system unless the potential seller makes a minimum firm commitment.

34. The method of claim 18, further comprising the step of reporting the consummation and terms of the transaction to the central processing system.

35. A method for anonymously and confidentially identifying contraparties to a transaction and disclosing contact information of the contraparties between the contraparties in order to allow them to negotiate a transaction, comprising the steps of:
receiving indications of interest from potential buyers and potential sellers into a central processing system, each indication of interest involving a purchase or sale of a specific item;
anonymously comparing indications of interest received from potential buyers with indications of interest from potential sellers within the central processing system to determine whether a match has occurred;
identifying contraparties to a transaction based on said determination of whether a match has occurred;
notifying each of the contraparties to a transaction that a match has occurred;
providing contact information to each of the contraparties to a transaction to allow the contraparties to contact each other to negotiate their transaction; and
consummating the transaction between the contraparties through direct negotiation between the contraparties.

36. The method of claim 35, wherein at least one of the received indications of interest involves the purchase or sale of an equity security.

37. The method of claim 35, wherein at least one of the received indications of interest involves the purchase or sale of a debt security.

38. The method of claim 35, wherein at least one of the received indications of interest involves the purchase or sale of a derivative security.

39. The method of claim 35, wherein at least one of the received indications of interest contains a limit as to the acceptable price per unit of the specific item that is the subject of its associated transaction.

40. The method of claim 35, wherein at least one of the received indications of interest contains a limit as to the minimum acceptable total value of its associated transaction.

41. The method of claim 35, wherein at least one of the received indications of interest contains a limit as to the minimum acceptable number of units to be purchased or sold in connection with a transaction.

42. The method of claim 35, wherein at least one of the received indications of interest includes ancillary information not used in determining whether a match has occurred in said comparing step but which is transmitted to a matched contraparty during said consummating the transaction step to assist in negotiations between the contraparties.

43. The method of claim 39, wherein a match between a potential buyer and a potential seller is not determined to have occurred in said comparing step unless any price per unit limits established by each of the potential buyer and the potential seller are satisfied.

44. The method of claim 40, wherein a match between a potential buyer and a potential seller is not determined to have occurred in said comparing step unless any minimum acceptable total values of the transaction established by each of the potential buyer and the potential seller, respectively, are satisfied.

45. The method of claim 41, wherein a match between a potential buyer and a potential seller is not determined to have occurred in said comparing step unless any minimum acceptable number of units established by each of the potential buyer and the potential seller, respectively, is satisfied.

46. The method of claim 35, wherein a match is not determined to have occurred between a potential buyer and a potential seller in said comparing step unless all input fields making up the indication of interest entered by the potential buyer matches all input fields making up the indication of interest entered by the potential seller.

47. The method of claim 35, wherein a match is determined to have occurred between a potential buyer and a potential seller in said comparing step even though all input fields making up the indication of interest entered by the potential buyer do not match all input fields making up the indication of interest entered by the potential seller.

48. The method of claim 35, wherein an indication of interest from a potential buyer is not received into the central processing system unless the potential buyer makes a good faith deposit.

49. The method of claim 35, wherein an indication of interest from a potential seller is not received into the central processing system unless the potential seller makes a minimum firm commitment.

50. The method of claim 35, further comprising the step of reporting the consummation and terms of the transaction to the central processing system.

51. An information management system for confidentially identifying contraparties to a transaction and introducing them and/or their agents to each other in order to allow them to negotiate the transaction, consisting of:
means for receiving indications of interest from potential buyers and potential sellers into a central processing system;
means for confidentially and anonymously comparing the received indications of interest from potential buyers and potential sellers to determine whether a match has occurred, and thus whether contraparties to a transaction have been identified; and
means for informing identified contraparties that a match has occurred and for providing contact information between the identified contraparties so that further negotiations may take place between the contraparties to consummate their mutually desired transaction.

52. A secure system for facilitating the trading of fungible commodities, including:
a network, including a secure station and a plurality of remote user terminals having respective user identities and communicatively linked to the secure station for data transmission between the secure station and the user terminals;
a memory at the secure station for storing user data and for storing transaction data in the form of multiple prospective transaction entries received from the user terminals, each of the entries including a fungible item indication and a transaction side indication identifying one of two opposing transaction sides;
a search component operatively coupled to the memory, adapted to perform a comparison of the stored entries with respect to the fungible item indications and the transaction side indications and, based on said comparison, to select sets of two or more of the stored entries as matching entries having the same fungible item indication and together including transaction side indications identifying the opposing transaction sides;
a message sending component operatively coupled to the search component and to the memory and adapted, in response to the selection of each said set of matching entries, to generate a prospective transaction message including the transaction indication and the user identity corresponding to each of the matching entries, and further adapted to provide the prospective transaction message to the user terminals associated with said corresponding user identities, thus to facilitate an interaction among users associated with the user terminals to complete a transaction involving the fungible item; and
a data security component for restricting access to any given prospective transaction entry stored in the memory to (i) the user identity corresponding to the given entry; and (ii) the user identities corresponding to the other entries in any of said sets of entries that includes the given entry.

53. The system of claim 52 wherein:
said message sending component provides the prospective transaction message substantially simultaneously to the user terminals associated with said corresponding user identities.

54. The system of claim 52 further including:
a menu for enabling users to select fungible item indications corresponding to different types of fungible items.

55. The system of claim 54 wherein:
said menu is stored in the memory.

56. The system of claim 52 wherein:
the data security component includes a plurality of user pages maintained at the secure station, each of the user pages being associated with and accessible only by one of the users.

57. The system of claim 52 wherein:
each of the prospective transaction entries includes a further indication selected from a group of further indications consisting of:
an amount indication designating an amount of the fungible item corresponding to the fungible item indication; a price indication designating an acceptable price or an acceptable price range; and a time limit indication.

58. The system of claim 57 wherein the further indication is an amount indication, and further includes:
an apportionment component, responsive to the selection of a set of matching entries that includes at least two entries having the same transaction side, for apportioning the designated amount of the fungible item among the user identities corresponding to the given transaction side.

59. The system of claim 57 wherein:
the memory includes an active segment for storing prospective transaction entries with none of said further indications and for storing entries including further indications that are satisfied; and a suspended segment for storing prospective transaction entries including a further indication which is not satisfied;
wherein the secure station further includes an entry monitoring component operatively associated with the active and suspended segments, for repeatedly monitoring the entries that include a further indication, to determine whether that further indication is satisfied; and
wherein said search component performs said comparison only upon the entries stored in the active segment of the memory.

60. The system of claim 59 wherein:
the memory further includes a pending segment for storing prospective transaction entries designated as pending by the corresponding users, and a means for shifting an entry from the pending segment to the active segment responsive to a signal from the corresponding user terminal activating the entry.

61. The system of claim 52 further including:
a status designation component enabling each user to alternatively designate a prospective transaction entry as active or pending;
wherein the memory includes an active memory segment for storing entries designated active, and an inactive segment for storing entries designated as pending; and
means for transferring an entry from one of said segments to the other in response to a change in the designation.

62. A process for facilitating the trading of fungible commodities, including:
receiving, from a plurality of remote user locations, user information including user identities, and transaction information in the form of prospective transaction entries, each of the entries including a fungible item indication and a transaction side indication identifying one of two opposing transaction sides;
storing the user information and the prospective transaction entries to a memory;
searching the memory to perform a comparison of the stored entries with respect to the fungible item indications and the transaction side indications;
based on said comparison, selecting matching entries to form sets of two or more of the matching entries having the same fungible item indication and together including transaction side indications identifying the opposing transaction sides;
in response to selecting each of the sets of entries, generating a prospective transaction message including the transaction indication and user identity corresponding to each of the matching entries, and providing the prospective transaction message to the user locations associated with the corresponding user identities, thereby to enable the associated users to contact one another toward a completion of transaction involving the fungible item; and
restricting access to any given prospective transaction entry to (i) the user identity corresponding to the given entry; and (ii) the user identities corresponding to the other entries in any of said sets of entries that includes the given entry.

63. The process of claim 62 wherein:
said providing the prospective transaction message includes providing said message substantially simultaneously to the user terminals associated with the corresponding user identities.

64. The process of claim 62 further including:
prior to receiving the prospective transaction entries from a given user, authorizing the given user based on the given user's meeting of predetermined qualification requirements.

65. The process of claim 62 wherein:
said restricting access includes maintaining at the secure location a plurality of user pages, each user page personalized to and accessible only by an associated one of the user locations.

66. The process of claim 62 wherein each of the prospective transition entries further optionally includes a condition, and the process further includes:
identifying the prospective transaction entries that includes a condition, and monitoring each of the entries so identified to determine whether the associated condition is satisfied.

67. The process of claim 62 wherein:
at least a portion of the prospective transaction entries include an amount indication associated with the fungible item indication, and the process further includes:
responsive to the selection of a set that includes at least two entries with the same transaction side indication, apportioning the fungible item among the users indicating said same side of the transaction.
